(19) United States
(12) Patent Application Publication
(10) Pub. No.: US 2023/0289130 A1
(43) Pub. Date: Sep. 14, 2023

(54) SYSTEMS AND METHODS FOR NOTIFYING VIDEO CONFERENCING STATUS WITH VISUAL STATUS INDICATOR

(71) Applicant: MuteMe LLC, EL DORADO HILLS, CA (US)

(72) Inventors: Paramveer Singh DHOOT, El Dorado Hills, CA (US); Handeep KAUR, El Dorado Hills, CA (US); Pavan PUREWAL, San Diego, CA (US)

(21) Appl. No.: 18/316,831

(22) Filed: May 12, 2023

Related U.S. Application Data
(63) Continuation of application No. PCT/US2021/055062, filed on Oct. 14, 2021.
(60) Provisional application No. 63/114,442, filed on Nov. 16, 2020.
(60) Provisional application No. 63/166,115, filed on Mar. 25, 2021.

(51) Int. Cl. G06F 3/16; H04R 3/00

(52) U.S. Cl. CPC G06F 3/165; H04R 3/00; H04R 2430/01

(57) ABSTRACT

Systems and methods of a visual device for video conferencing are described herein. In some aspects, a visual system for controlling a webcam includes a visual device configured to control to change a setting of a computer webcam in response to an event, a visual device operably coupled to a webcam controller. The webcam includes event handling logic for receiving a signal from the visual device of the event and communicating with a webcam controller. The system also includes a visual device coupled to the webcam controller configured to execute a detecting script to enable/disable the webcam, a visual device coupled to the webcam controller including a webcam screen status detection, and a visual device coupled to the webcam controller and configured to control a virtual or non-virtual webcam.

This application is a continuation of Application No. PCT/US2021/055062, filed Oct. 14, 2021, which claims the benefit of U.S. Provisional Application No. 63/114,442, filed Nov. 16, 2020, and claims the benefit of U.S. Provisional Application No. 63/166,115, filed Mar. 25, 2021. The aforementioned application is incorporated by reference herein in its entirety, and is hereby expressly made a part of this specification.

### BACKGROUND

Speaking with anyone around the world through a virtual meeting has become significant during the COVID-19 pandemic. But, frequent video conferencing problems have been the cause of embarrassment because either the person using virtual meetings did not know their microphones were on or other people have walked in on their meetings and disrupted the meeting. As a result, there remains a need to allow users and those around the user to know if a video conference is occurring and if a microphone is on.

### SUMMARY OF THE DISCLOSURE

Some aspects described herein relate to a visual system for controlling a microphone. In some embodiments, the visual system for controlling a computer microphone includes a visual device having configurable control to change a setting of a computer microphone in response to an event such as a user touch on the visual device. In some embodiments, an operating system is operably coupled to a microphone controller, the operating system having event handling logic for receiving a signal from the visual device and communicating with the computer operating system microphone controller.

In some embodiments, the visual device further comprises one or more visual indicators. In some embodiments, the one or more visual indicators are one or more LED lights. In some embodiments, the visual device is wirelessly connected to the operating system. In some embodiments, the visual device is wirelessly connected to the Internet through WiFi or other wireless networking technology. In some embodiments, the visual device comprises a wired connection between the visual device and the operating system. In some embodiments, the system further comprises a toggle operably coupled to the operating system for inputting a command to change a setting of the microphone controller. In some embodiments, the toggle comprises a volume control for muting or unmuting the microphone controller. In some embodiments, the toggle comprises a component with control handling logic for receiving commands from the visual device. In some embodiments, the visual device further comprises a microcontroller. In some embodiments, the visual device further comprises a button or sensor capable of discerning touch.

Some aspects of the disclosure relate to a method of controlling a computer microphone. In some embodiments the method includes receiving an event such as attending a video conferencing call, communicating the event to a visual device, and changing the setting on the visual device to indicate the status of a microphone during the video conferencing call.

In some embodiments, the receiving event comprises receiving an event generated by an application. In some embodiments, the receiving event comprises receiving an event generated by a video conferencing call. In some embodiments, the changing the setting of the visual device comprises changing a visual indicator from the visual device. In some embodiments, the setting of the visual device comprises muting the default audio output of the microphone during the video conferencing call.

In some embodiments, a method of controlling a computer microphone includes pushing a button on the visual device thereby activating the visual device; communicating the visual device activation to a computer; changing a microphone setting on the computer as a result of the visual device activation. In some embodiments, changing the setting on the computer results in muting the microphone. In some embodiments, changing the setting on the computer results in activating the microphone. In some embodiments, the activating the visual device comprises activating a visual indicator on the visual device. In some embodiments, the visual indicator comprises one or more LED lights. In some embodiments, the visual indicator comprises one or more LED lights.

One aspect is a visual system for controlling a microphone, comprising: a visual device having configurable control to change a setting of a computer microphone in response to an event; and an operating system operably coupled to a microphone controller, the operating system having event handling logic for receiving a signal from the visual device of the event and communicating with the computer operation system microphone controller.

In some embodiments, the visual device further comprises one or more visual indicators.

In some embodiments, the one or more visual indicators is comprise one or more LED lights.

In some embodiments, the visual device is wirelessly connected to the operating system.

In some embodiments, the visual device comprises a wired connection between the visual device and the operating system.

In some embodiments, the visual system further comprises a toggle operably coupled to the operating system for inputting a command to change a setting of the microphone controller.

In some embodiments, the toggle comprises a volume control for muting or unmuting the microphone controller.

In some embodiments, the toggle comprises a component with control handling logic for receiving commands from the visual device.

In some embodiments, the visual device further comprises a microcontroller.

In some embodiments, the visual device further comprises a button or a touch sensor.

Another aspect is a method of controlling a computer microphone, comprising: receiving an event; communicating the event to a visual device; and changing the setting on the visual device to indicate the status of a microphone during the video conferencing call.

In some embodiments, the receiving event comprises receiving an event generated by an application.

In some embodiments, the receiving event comprises receiving an event generated by a video conferencing call.

In some embodiments, the changing the setting of the visual device comprises changing a visual indicator from the visual device.

In some embodiments, changing the setting of visual device comprises muting the default audio output of the microphone during the video conferencing call.

Yet another aspect is a method of controlling a computer microphone, comprising: pushing a button on the visual device thereby activating the visual device; communicating the visual device activation to a computer; and changing a microphone setting on the computer in response to a signal received by the visual device.

In some embodiments, changing the setting on the computer results in muting the microphone.

In some embodiments, changing the setting on the computer results in activating the microphone.

In some embodiments, the activating the visual device comprises activating a visual indicator on the visual device.

In some embodiments, the visual indicator comprises two or more LED lights.

Still yet another aspect is a visual system for controlling a webcam, comprising: a visual device configured to control to change a setting of a computer webcam in response to an event; a visual device operably coupled to a webcam controller, the webcam comprising event handling logic for receiving a signal from the visual device of the event and communicating with a webcam controller; a visual device coupled to the webcam controller configured to execute a detecting script to enable/disable the webcam; a visual device coupled to the webcam controller comprising a webcam screen status detection; and a visual device coupled to the webcam controller and configured to control a virtual or non-virtual webcam.

In some embodiments, the visual device further comprises one or more visual indicators.

In some embodiments, the one or more visual indicators comprises one or more LED lights.

In some embodiments, the visual device is configured to be wirelessly connected to the webcam controller.

In some embodiments, the visual device is configured to be connected to the operating system using a wired connection.

In some embodiments, the visual device comprises a USB connection configured to connect to the operating system.

In some embodiments, the system further comprises a toggle operably coupled to the webcam controller and configured to receive a command to change a setting of the webcam controller.

In some embodiments, the toggle comprises a component configured to receive commands from the visual device.

In some embodiments, the visual device further comprises a microcontroller.

In some embodiments, the visual device further comprises a button.

In some embodiments, the visual device further comprises a touch sensor or voice command receiver.

Another aspect is a method of controlling a computer webcam, comprising: receiving an event; communicating the event to a visual device; and changing the setting on the visual device to indicate the status of a webcam during the video conferencing call.

In some embodiments, the receiving event comprises receiving an event generated by an application.

In some embodiments, the receiving event comprises receiving an event generated by a video conferencing call.

In some embodiments, the changing the setting of the visual device comprises changing a visual indicator from the visual device.

In some embodiments, changing the setting of visual device comprises turning off the default video output of the webcam during the video conferencing call.

Yet another aspect is a method of controlling a computer webcam, comprising: pushing a button on the visual device thereby activating the visual device; communicating the visual device activation to a computer; and changing a webcam setting on the computer as a result of the visual device activation.

In some embodiments, changing the setting on the computer results in turning off the webcam.

In some embodiments, changing the setting on the computer results in activating the webcam.

In some embodiments, the activating the visual device comprises activating a visual indicator on the visual device.

In some embodiments, the visual indicator comprises two or more LED lights.

Still yet another aspect is a visual system for controlling a webcam, comprising: a visual device configured to change a setting of a computer webcam in response to an event; a visual device coupled to a virtual webcam, the virtual webcam configured to receive a signal from the visual device of the event and communicate with the computer virtual webcam through human interface devices (HID) commands; a visual device coupled to a webcam controller configured to execute a plug and play (PnP) detecting script for the webcam; and a visual device coupled to the webcam controller and configured to perform screen webcam status detection.

In some embodiments, the visual device further comprises one or more visual indicators.

In some embodiments, the one or more visual indicators comprises one or more LED lights.

In some embodiments, the visual device is configured to be wirelessly connected to the virtual webcam.

In some embodiments, the visual device is configured to connect to the virtual webcam via a wired connection.

In some embodiments, the visual device comprises a USB connection configured to connect to the virtual webcam.

In some embodiments, the system further comprising a toggle operably coupled to a webcam software configured to receive a command to change a setting of the virtual webcam.

In some embodiments, the toggle comprises a component configured to receive commands from the visual device.

In some embodiments, the visual device further comprises a microcontroller.

In some embodiments, the visual device further comprises a button.

In some embodiments, the visual device further comprises a touch sensor or voice command.

Another aspect is a method of controlling a computer webcam, comprising: receiving an event; communicating the event to a visual device; and changing the setting on the visual device to indicate the status of a webcam during the video conferencing call.

In some embodiments, the receiving event comprises receiving an event generated by an application.

In some embodiments, the receiving event comprises receiving an event generated by a video conferencing call.

In some embodiments, the changing the setting of the visual device comprises changing a visual indicator from the visual device.

In some embodiments, changing the setting of visual device comprises turning off the default video output of the webcam during the video conferencing call.

Yet another aspect is a method of controlling a computer webcam, comprising: pushing a button on the visual device thereby activating the visual device; communicating the visual device activation to a computer; and changing a webcam setting on the computer as a result of in response to the visual device activation received communication of the visual device activation.

In some embodiments, changing the setting on the computer results in turning off the webcam.

In some embodiments, changing the setting on the computer results in activating the webcam.

In some embodiments, the activating the visual device comprises activating a visual indicator on the visual device.

In some embodiments, the visual indicator comprises two or more LED lights.

Still yet another aspects is a visual system for controlling a virtual webcam, comprising: an output stream configured to be turned on and off by the visual device system; an output stream that configured to be applied to multiple video conference software programs; an output stream configured to be controlled both by the user and and/or an organization associated with the user; and an output stream configured to provide different views when on, and different views when off.

In some embodiments, the output video stream configured to conditionally change, depending on: the time, and/or location, of a user; company or team parameters including at least one of: events, emergencies, and/or branding initiatives; and the color(s) of the visual device system are configured to be selected.

Another aspect is a peripheral device configured to control user-specific customized lens in a virtual camera software application using a user's computer's webcam.

Yet another aspect is a peripheral device configured to turn user-specific customized lens on, off or toggle through various selections.

Still yet another aspect is a peripheral device configured to control user-specific customized lens in a video conference application.

Another aspect is a user-specific customized lens that is configured to be controlled via a peripheral, illuminated device that communicates status of the lens being on, off, or other lens option status.

Yet another aspect is a user-specific customized lens that configured to communicate information in a video conference application setting to users on the other end when the camera is on.

In some embodiments, the communication comprises at least one of the following: text, via border, and via a bar of text appearing on top of video image, permanently or temporarily or when hovered over with a mouse.

Still yet another aspect is a user-specific customized lens that configured to communicate information in a video conference application setting to users on the other end when the camera is off.

In some embodiments, the communication comprises at least one of the following: text, via border, via a bar of text appearing on top of video image, permanently or temporarily or when hovered over with a mouse, and via an image, logo, or other visual posted.

Another aspect is a peripheral device configured to connected connects a user's computer that illuminates one or more colors indicating status changes in virtual meeting applications.

Yet another aspect is a multi-sensor peripheral device configured to connect to a user's computer and illuminate to indicate on/off functionality of a microphone, camera, and speakers connected to the user's computer.

Still yet another aspect is a peripheral device configured to connect to a user's computer and to control the user's microphone and/or camera at the operating system level/driver level.

Another aspect is a multi-sensor USB HID device configured to connects to a user's computer to control virtual meeting commands at an operating system level.

Yet another aspect is a peripheral device configured to illuminate to show both microphone and camera status on a user's computer.

Still yet another aspect is a visual system for controlling a microphone, comprising: a visual device configured to change a setting of a computer microphone in response to an event; and a screen reading controller configured to detect a mute/unmute status of the computer microphone when a user mutes/unmutes using conferencing software and/or the visual device system.

Another aspect is a visual system for controlling a microphone, comprising: a visual device configured to change a setting of a computer microphone in response to an event; and a microphone controller configured to enable/disable a microphone driver using a detecting script when a user mutes/unmutes using conferencing software and/or the visual device system.

In some embodiments, the detecting script comprises a plug and play (PnP) detecting script.

Yet another aspect is a visual system for controlling a microphone, comprising: a visual device configured to change a setting of a computer microphone in response to an event; and a virtual microphone configured to receive commands from the visual device.

In some embodiments, the received commands comprise human interface devices (HID) commands.

In some embodiments, the system is configured to controls the virtual microphone and the virtual microphone is configured to controls or receive input from the computer microphone.

In some embodiments, the virtual microphone is configured to connect to conferencing software.

In some embodiments, the system is configured to receive a selection from a user to select the virtual microphone as a default microphone, wherein the visual device system further comprises microphone software configured to pass along commands from the visual device system peripheral to the computer.

In some embodiments, the system is configured to perform two-way synchronization without the need to use keyboard commands.

In some embodiments, the virtual microphone is configured to sync with a conferencing application and pass along and receive USB commands as if the virtual microphone was a real microphone with the visual device system.

In some embodiments, the system can be configured to have specific microphone(s) and/or camera(s) being controlled by the visual device.

In some embodiments, the visual device application (e.g., virtual MuteMe device and/or virtual microphone controller) is configured to receive a signal and communicate the signal to the physical visual device and the application (which may be referred to as “all in sync”).

Another aspect is a method of detecting when a user is active on a video conferencing call.

In some embodiments, visual device is configured to receive instructions from a user to select a different color, or have the visual device turned completely off when not on a call.

In some embodiments, the visual device may have at least three different LED settings, including a first setting when the user is on a call and unmuted, a second setting when the user is on a call and muted, and a third setting when the user is not on a call.

In some embodiments, a receiving event comprises receiving an event by the visual device that changes the status of the webcam, microphone, logs the user out, or any combination thereof.

### BRIEF DESCRIPTION OF THE DRAWINGS

FIGS. 1A-1I illustrate a visual device system in accordance with embodiments of the disclosure.

FIG. 2 illustrates an example of a user being muted and talking.

FIG. 3 illustrates an example of an unmuted user and listening to a video conference.

FIG. 4 illustrates an example of a muted user.

FIG. 5 illustrates an example of an unmuted user.

FIG. 6 illustrates an aspect of the visual device with two distinct visual colors from LED lights.

FIG. 7 illustrates an aspect of the visual device and customization of colors for people who are color blind.

FIG. 8 illustrates an aspect of the visual device connected to a computer with two distinct LED light settings.

FIG. 9A illustrates an aspect of a miniaturized visual device. FIG. 9B illustrates a different view of the aspect of the miniaturized visual device of FIG. 9A.

FIGS. 10A-10D illustrate four examples of a user's webcam being on and not knowing.

FIGS. 11A-11B illustrate views of a visual device system in accordance with an embodiment of the disclosure.

FIGS. 12A-12D illustrate a number of views of an embodiment of the visual device system with examples of different capabilities of the device.

FIG. 13 illustrates a number of different form factors in which the visual device can be implemented in accordance with aspects of this disclosure.

FIGS. 14A-14B illustrates an embodiment of a virtual device camera system that sits on the user's computer and allows the user to customize their output video feed.

FIGS. 15A-15B illustrates the internal design of a visual device in accordance with aspects of this disclosure.

FIG. 16 illustrates a block diagram which can implement the microphone mute/unmute synchronization system.

FIG. 17 illustrates another embodiment of the webcam on/off synchronization system which may be coupled to up to three different webcam control systems.

FIG. 18A illustrates an embodiment of a motion activated visual device system.

FIG. 18B illustrates another embodiment of a visual device and a computing device.

FIG. 19 illustrates an embodiment of a motion activated visual device system configured to unlock based on one or more sign-on conditions.

FIG. 20 illustrates an embodiment of a visual device system as IOT device.

FIGS. 21A-21C illustrate embodiments of user-to-user connected visual device system use cases. Users can see other visual device systems and their status in multiple use cases.

FIGS. 22A-22B illustrate examples of user-to-user connected visual device system technologies.

FIG. 23 illustrates an example user-to-user connected visual device system.

FIG. 24 illustrates an example visual device system busy sensor.

### DETAILED DESCRIPTION OF THE DISCLOSURE

Knowing when you are on mute or unmute is not always obvious to the computer user, virtual meeting participants or those physically around them.

When using the computer, the status of a microphone included in or connected to the computer may be obscured by multiple windows being open, a particular program being minimized, or a user may be inattentive to the microphone state by using multiple monitors. Typically, knowing when your microphone is muted or unmuted requires locating the online conference window and identifying the condition of the microphone icon.

For those who cannot see the user's screen, knowing if the user's microphone is muted or not can be difficult. For example, if a remote worker (Person A) is on a conference call, a household member (Person B) may need to convey a message, but cannot identify the mute/unmute status. If Person B does deliver the message and the user is unmuted, this can disrupt the conference call.

For those concerned about security and confidentiality, being muted at the system-level can serve as peace of mind. Instead of being muted only with the specific software, being muted at the operating system level ensures no one, regardless of how many online conferencing applications that might be open, will hear your unintended conversations.

This disclosure relates to systems and methods that allow the user and those around them to immediately identify if the user's microphone is muted or unmuted by providing a large visual indicator that works directly with the computer's system microphone. Implementations of aspects of this disclosure may decrease the amount of confusion and frustration for both computer users and those physically around them who are mistaken or unaware about whether the microphone is muted or not, especially with the rise of remote work and various conferencing solutions due to COVID-19. In addition, aspects of this disclosure let the user and those physically around know if the user is engaged in an online conference. Additional benefits of aspects of this disclosure include immediately identifying if the user's microphone is muted or unmuted combined with enabling the user to react more quickly to avoid disruption to the online conference based on the indication in at least the instances mentioned above. Accordingly, aspects of this disclosure can reduce the time it takes for a user to mute/unmute a microphone connected to the user's computer.

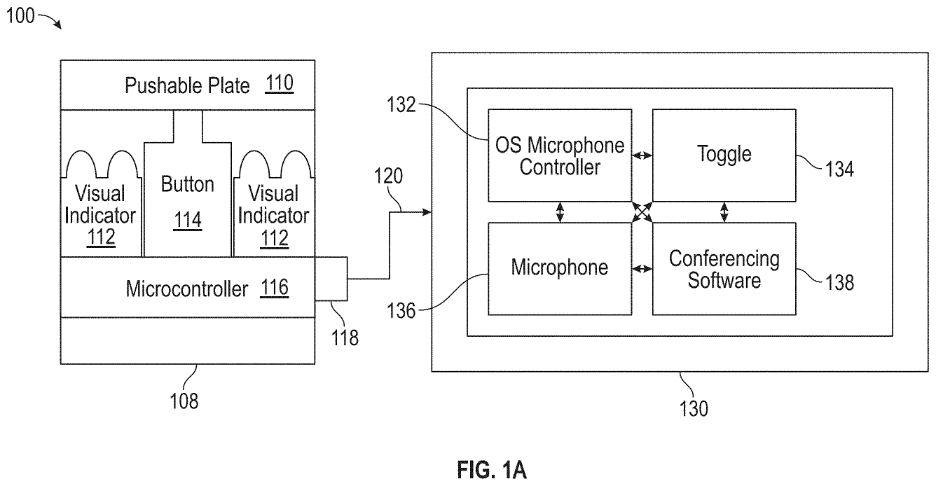

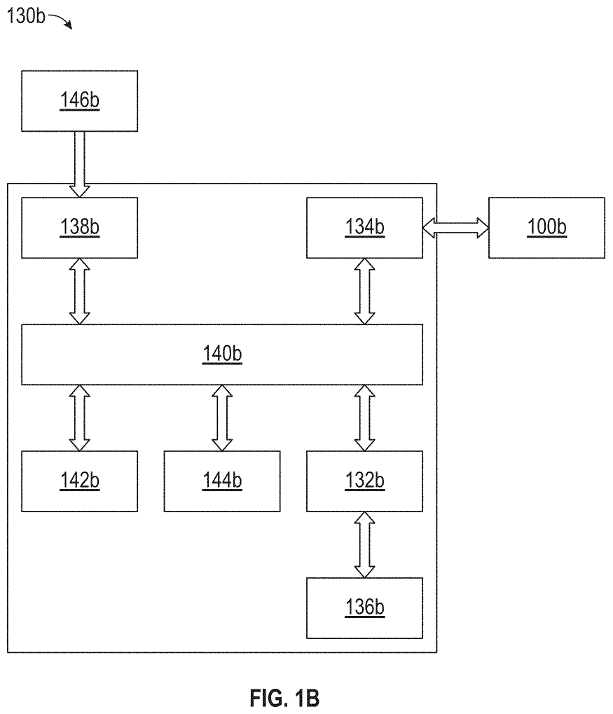

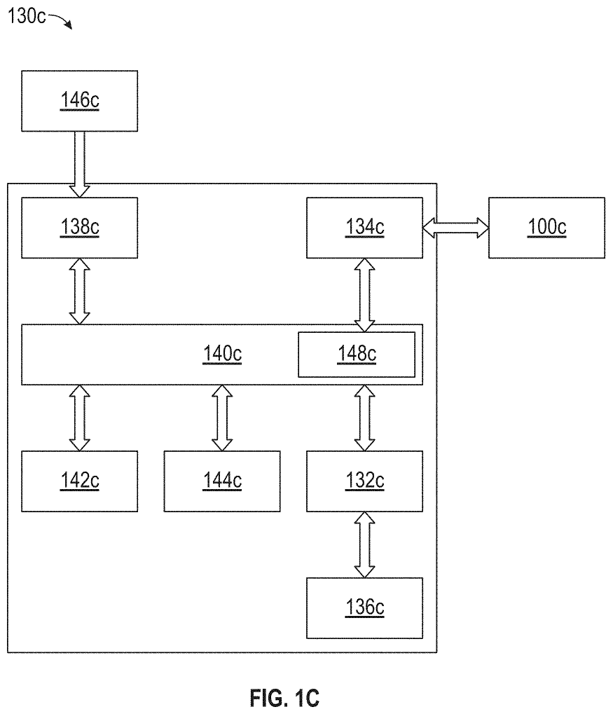

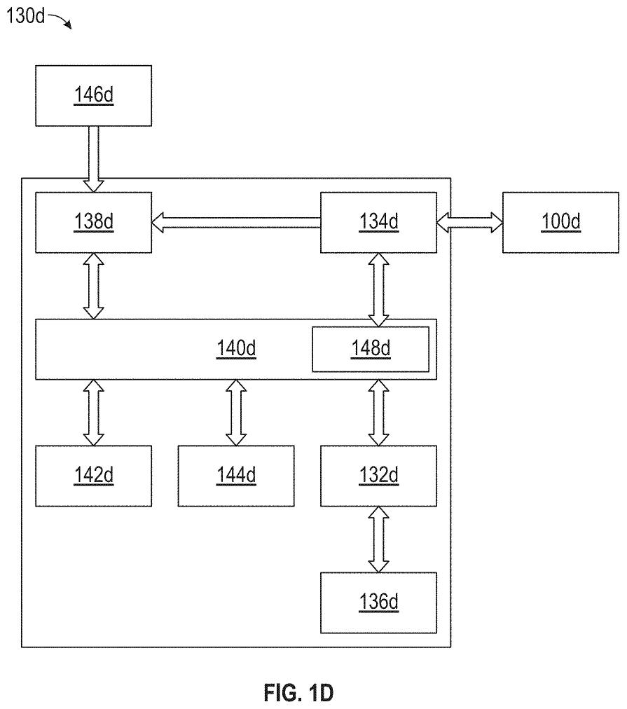

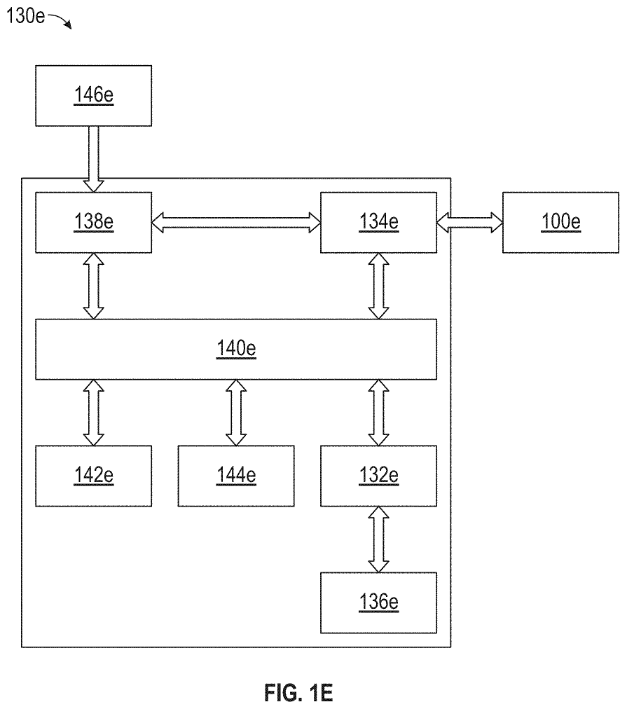

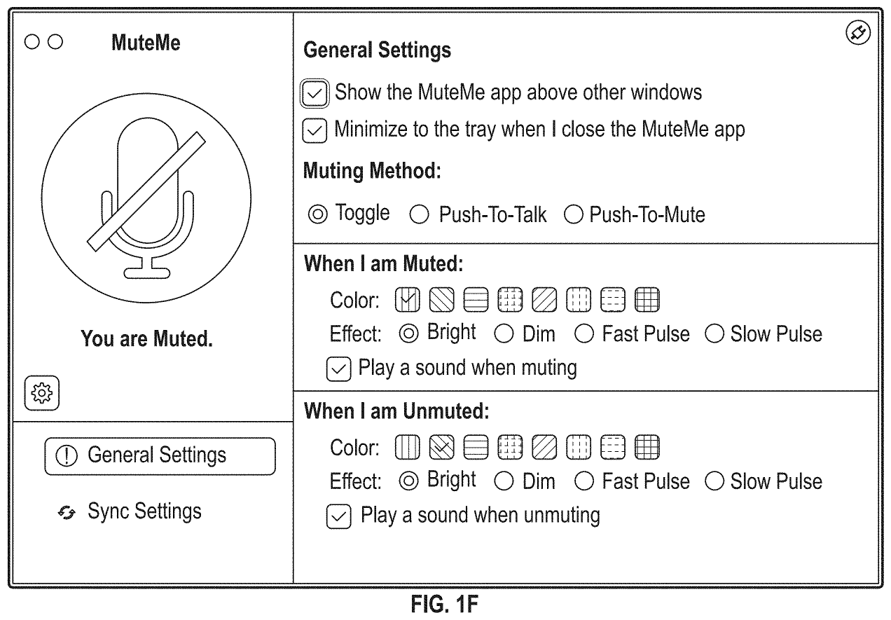

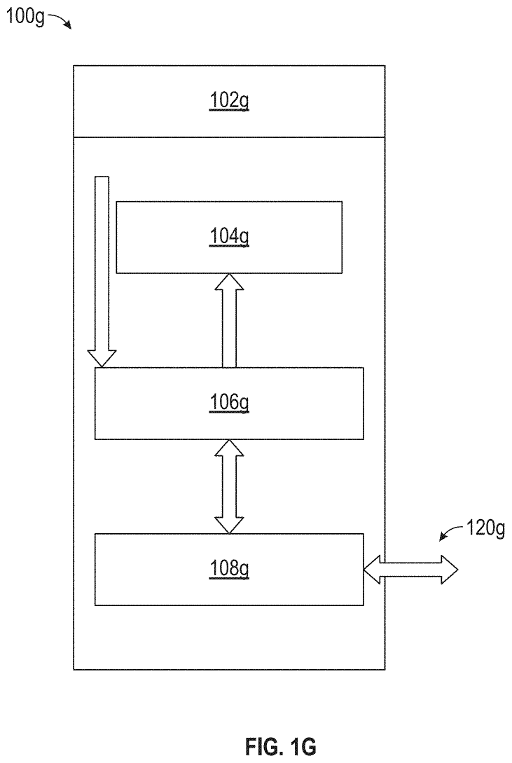

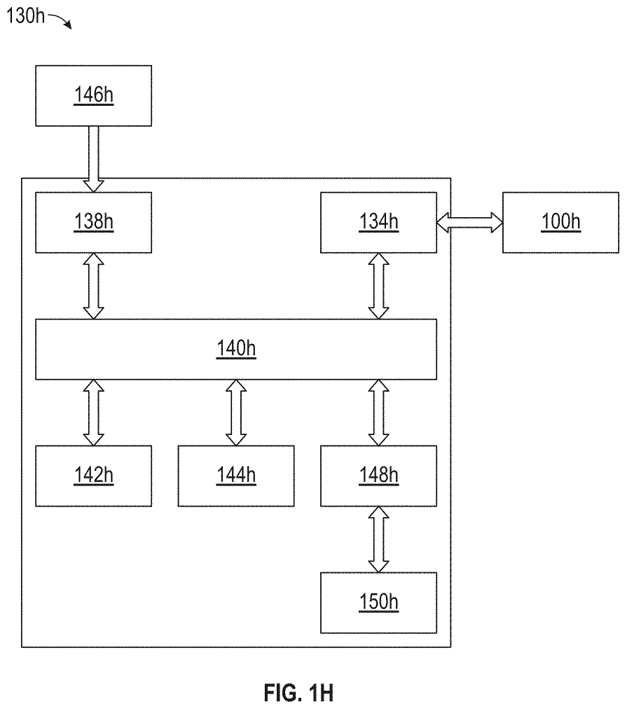

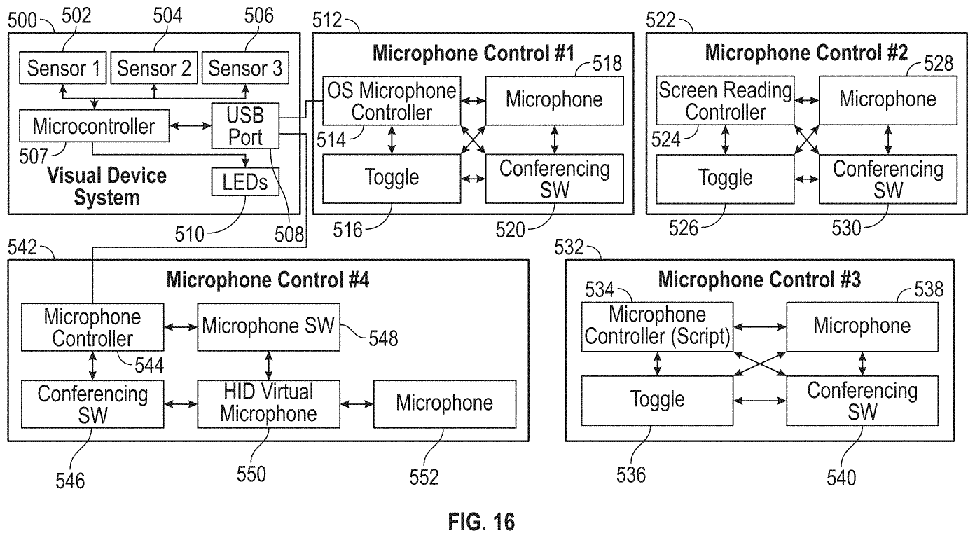

FIG. 1A illustrates a visual device 100 in accordance with some embodiments of the disclosure. The visual device 100 includes a housing 108, a pushable plate 110, one or more visual indicators 112, a button 114, a microcontroller 116, and a universal serial bus (USB) port 118. In some embodiments, the visual device can also include a touch sensor (e.g., capacitive touch plate) in addition to or in place of the pushable plate (110) and/or the button 114. The USB port 118 is operatively connected 120 to a computer 130. The computer 130 includes an operating system (OS) microphone controller 132, a toggle 134, a microphone 136, and conferencing software 138. In some embodiments, the microphone controller 132 need not be an OS microphone controller as is described herein (e.g., see FIG. 16 and the associated description). In some embodiments, the conferencing software 138 includes commercial software platforms and applications (for example, Zoom, Microsoft Teams, GoToMeeting, Skype, ezTalks Meetings, StarLeaf, Cisco Webex, etc.). In some embodiments, the conferencing software 138 is operably connected to the toggle 134 and the OS microphone controller 132. In some embodiments, the toggle 134 can detect the state of the conferencing software 138 and determine the status of the computer's 130 microphone. In some embodiments, the toggle 134 communicates to the visual device 100 the microphone 136 status when the conferencing software 138 is operational so that the one or more visual indicators may reflect the status of the microphone 136.

In some embodiments, the pushable plate 110 is depressed into the button 114 to activate or deactivate the one or more visual indicators 112. The one or more visual indicators 112 may have one or more sets of visual indicators. For example, a user pushes on the pushable plate 110 a first instance and the one or more visual indicators produces a red light. A user pushes on the pushable plate 110 a second time to change the one or more visual indicators to a green light. Allowing the user or anyone in the user's vicinity to see the status of the visual device 100. In some embodiments, the visual device 100 may include one or more computing processors.

In some embodiments, the visual device 100 is connected to a computer 130 by a physical connection 120. The microcontroller 116 is coupled to a USB port 118 to be in physical connection 120 with a computer 130. The OS microphone controller 132 is coupled to a toggle 134 on the computer that is capable of muting or unmuting the microphone 136. In some embodiments, a user depresses the pushable plate 110 onto a button 114 which activates the visual indicator 112. The microcontroller 116 detects the activation of the visual indicators 112 and sends a signal from the USB port 118 to the computer 130 through a connection 120. The toggle 134 detects the signal being sent from the microcontroller 116 through the USB port 118 and the connection 120 to cause the OS microphone controller 132 to activate or deactivate the microphone 136.

In some embodiments, the connection 120 between the visual device 100 and the computer is a physical connection 120. In some embodiments, the physical connection is a wire connection between the USB port 118 and the computer 130. In certain embodiments, the USB port 118 may be replaced or supplemented with another port implemented using a different standard, for example, a Thunderbolt port. In some embodiments, the connection 120 between the visual device 100 and the computer 130 is a wireless connection 120. In some embodiments, the wireless connection 120 is a WiFi connection. In some embodiments, the wireless connection 120 is a Bluetooth connection. In some embodiments, the wireless connection 120 is a cellular connection (such as 4G or 5G). In some embodiments, the wireless connection 120 is a radio frequency connection.

In some embodiments, the one or more visual indicators 112 include one or more lights. In some embodiments, the lights are one or more light emitting diode (LED) lights. However, aspects of this disclosure are not limited to the visual indicators 112 including one or more lights and other types of visual indicators can be used without departing from aspects of this disclosure. For example, the one or more visual indicators 112 can include one or more of the following: electronic ink (e-ink) and mechanical visual indicators (e.g., a flag going up or down, a closing of a camera shutter, etc.).

In some embodiments, the USB port 118 is USB type A. In some embodiments, the USB port 118 is a USB type B. In some embodiments, the USB port 118 is a USB type C. In some embodiments, the USB port 118 is a USB type A mini. In some embodiments, the USB port 118 is a USB type B mini. In some embodiments the USB port 118 is a USB type A micro. In some embodiments the USB port 118 is a USB type B micro.

In some embodiments, the housing 108 can be formed with molded plastic. In some embodiments, the housing 108 can include metal components, glass components, carbon fiber components or other lightweight materials.

In some embodiments, the computer 130 is a general-purpose computer. In some embodiments, the computer 130 is a special purpose computer. Examples of well-known computing systems, environments, and/or configurations that may be suitable for use with-the disclosure include, but are not limited to: personal computers, server computers, hand-held or laptop devices, tablet devices, phone devices, headless servers, multiprocessor systems, microprocessor-based systems, set top boxes, programmable consumer electronics, network personal computers (PCs), minicomputers, mainframe computers, distributed computing environments that include any of the above systems or devices, and the like. The disclosure may also be described in the general context of computer-executable instructions, such as program modules, being executed by a computer. Generally, program modules include routines, programs, objects, components, data structures, and so forth, which perform particular tasks or implement particular abstract data types.

In some embodiments, the visual device 100 responds to an event. In some embodiments, the event can include the powering on of the computer 130, the start of a video conference, a change in the microphone 136 setting, or touching the pushable plate 110 of the visual device 100. Other examples of events to which the visual device 100 can respond include but are not limited to: incoming calls, ending calls, raising a hand, screen sharing, chat message, and/or other features available on conference software.

There are many applications that may use the present disclosure for automatic control of audio devices based upon the user's context. For example, if a user connects a visual device 100 to a computer 130, the computer 130 master audio controller may switch the default system audio output to the visual device 100. The microphone 136 is muted so that they do not disturb others. When the user disconnects the visual device 100, the master audio controller switches the default system audio output device and restores their microphone control to the computer 130.

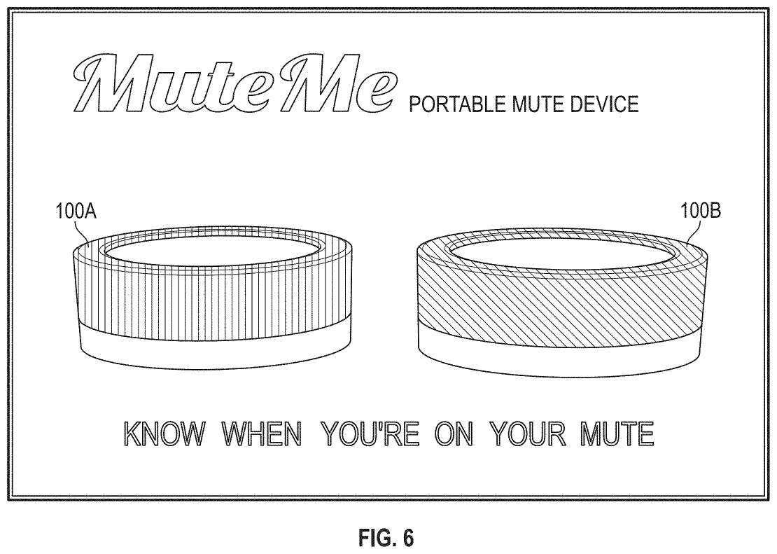

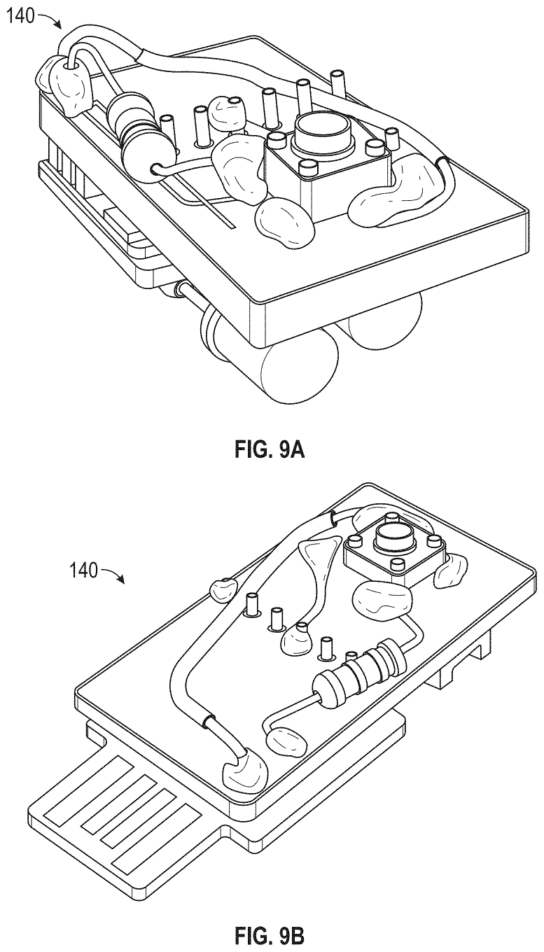

In some embodiments, the visual device 100 can be configured to various form factors. For example, it can be a disk type shape as shown in FIG. 1A, or be a cylindrical as shown in FIG. 6, spherical, cube, miniaturized as shown in FIG. 9A, etc. All shapes and configurations are contemplated as long as the device can relay clearly to the computer user and those around them the mute/unmute status. In some embodiments, the visual device 100 can be small to large and can include attachment means for the device to adhere to computers, walls, sit on a flat surface, or attached to the user enabling the user to be mobile during the call. In some embodiments, the attachment may include Velcro, clip, magnets, adhesive, physical weight, etc.

In some embodiments, the visual device 100 may be embedded in a bracelet, watch, or even be incorporated as part of a peripheral device with the microphone 136 or camera.

In some aspects, a method of controlling a microphone 136 is described herein. In some embodiments, the method allows both users and those physically and virtually present to instantly know if the user's microphone 136 is muted/unmuted, if the user is participating in a conference call, and to provide peace of mind that the user is muted at an operating system level.

In some embodiments, the method allows a user to mute their microphone 136 across all applications at the system level. In some embodiments, the method visually alerts the user and those around them if they are muted. In some embodiments, the method allows a user to visually alert both the user and those around of the mute status by using a visual indicator, like LED lights. By pressing the button 114, the visual device 100 can toggle between being muted and unmuted. For example, by turning red to indicate the microphone 136 is muted or turning green to indicate the microphone 136 is on. The lights from the one or more visual indicators 112 clearly showing the user and those around them if the microphone 136 is muted or not. In some embodiments, the microphone 136 is activated by other means than a button 114 or a pushable plate 110. For example, the microphone 136 may be controlled by voice command, RADAR, LIDAR, touch screen, touch sensor (e.g., capacitive touch sensor), other sensory device, etc.

In some embodiments, the method includes receiving an event, communicating the event to a visual device, and changing the setting on the visual device to indicate the status of the microphone 136 during the video conferencing call.

In some embodiments, the visual device 100 is capable of relaying status change by a visual indication, a sound, an on-screen indication, displayed text, or mechanical movement.

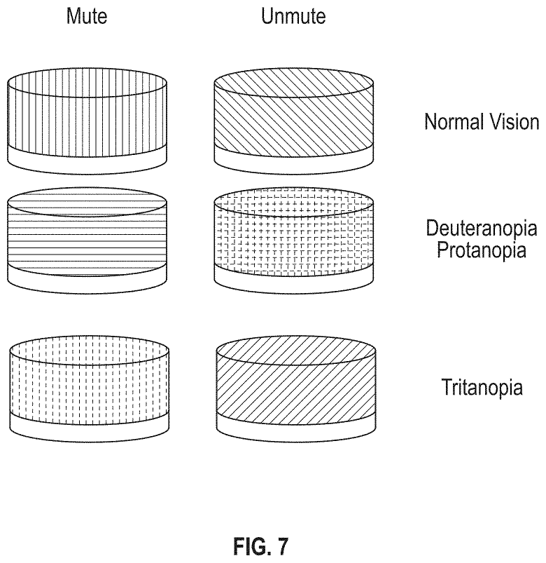

In some embodiments, the one or more visual indicators 112 may provide visual status changes for people who are color blind. Color blindness affects 1 in 12 men (8%) and 1 in 200 women (0.5%). To accommodate these users, the one or more visual indicators 112 may have the ability to customize colors for its LED lights as seen in FIG. 7.

In some embodiments, the visual device 100 can include one or more sound indicators (e.g., speaker or other device configured to output audible feedback) to provide audible feedback in addition to or in place of the visual status changes for people who are visually impaired or blind. In one example, the sound indicator(s) can provide a single tone indicating that the microphone is muted and a double tone indicated that the microphone is unmuted. In some embodiments, the visual device 100 can also include haptics to provide haptic feedback (such as vibration or rumble) indicating whether the microphone is muted or unmuted. Thus, the visual device 100 can provide status indications to both the user and/or people in the same environment as the user in both visual and non-visual (e.g., audible and/or haptic) formats.

In some embodiments, the visual device 100 may include the ability to tell users and those physically around them if the user is engaged in an active conference call by retrieving this information from the OS. When the user is on an active call, the status light (e.g., visual indicator 112 such as an LED) can pulsate. This additional information is helpful to know to determine if the user is engaged in a call, if the user is muted/unmuted during a conference call, or if the user is not in an active call at all.

In some embodiments, the visual device 100a can detect when video conferencing applications (for example, Zoom) are launched by communicating with the OS of the computer 130a. In one embodiment, launching the video conferencing application automatically sets the OS microphone controller 132a status to unmute, which is then carried over to the visual device 100a, which sets the visual indicator to a color (such as green) corresponding to unmute status of the microphone 136a. In other embodiments, the video conferencing can automatically set the OS microphone controller 132 status to mute, e.g., when launching a video conference. The aforementioned automatic mute or unmute status may be set based on a user preference. In some embodiments, the toggle software 134 can then use system commands to control the mute/unmute status during video or call conferencing. The visual device 100 is compatible with various OS platforms such as but not limited to Windows, MacOS, Chrome OS, Linux and can work with various conferencing applications. In some embodiments, the toggle software 134 allows the visual device 100 to first detect the status (mute or unmute) of the microphone 136, and then change the color of the one or more visual indicators 112 to reflect the status of the microphone 136. The user can then push the pushable plate 110 to switch the microphone 136 between mute/unmute status. The visual device 100 software also monitors if other software of the computer 130 (such as the conferencing software 138) is attempting to change the status of the microphone 136 and if the user is actively engaged in a call/conference. In some embodiments, the software can change the status of the OS microphone controller 132.

In some embodiments, the visual device 100 can detect when the computer is asleep/off and also turn itself off accordingly. In some embodiments, the brightness of the visual device's 100 visual indicator light can also be adjusted, for example, based on a signal received from an ambient sensor or based on an input received from the user.

As will be understood, the various architecture diagrams, devices and scenarios described herein are only examples, and there are many other scenarios to which the present invention will apply. As mentioned above, though denoted as visual device, the visual device may use non-visual ways (such as sound) to notify the user whether the microphone is muted or not. Further, the term “visual device” is used interchangeably below with the term “fast control device” to reflect the capability of providing quick muting or unmuting control on a microphone.

FIG. 1B illustrates an embodiment of a system for muting or unmuting a microphone 136b connected to a computing device 130b by using a fast control device 100b. The computing device 130b may be a laptop, desktop, smartphone, tablet, a smart TV, or other electronic devices. The microphone 136b can be a built-in microphone of the computing device 130b, wired (such as USB) or wirelessly (such as Bluetooth) connected to the computing device 130b. The microphone 136b can be muted or unmuted at the application level or the OS level, which will be described in more detail. The computing device 130b has an operating system 140b, an application program 138b, a fast control program 134b, a central processing unit 142b, a memory 144b and a microphone driver 132b. The fast control device 100b has a contact unit (such as a touch panel or a button) that is used to mute or unmute the microphone when contacted by a user. The fast control device 100b can be wired (such as USB-A or USB-C) or wirelessly (such as Bluetooth) connected to the computing device 130b. The fast control device 100b may also have a light source, indicating whether the microphone 136b is mute or unmute.

The microphone 136b can be muted or unmuted by the application program 138b through an input device 146b (such as a mouse) of the computing device 130b. The application program 138b may be a video conference program such Zoom, Line, Webex, Skype, Google Meet, GoToMeeting, Microsoft Teams or other video conferencing programs. In some embodiments, a user may mute the microphone 136b by using the mouse to click on a mute icon presented by the graphical user interface (GUI) of the application program 138b.

The microphone 136b can also be muted or unmuted by the fast control program 134b through the fast control device 100b. The fast control program 134b is a software program specifically developed to coordinate with the fast control device 100b to quickly and reliably mute or unmute the microphone 136b. In some embodiments, a user may mute or unmute the microphone 136b by touching or pressing the contact unit of the fast control device 100b, eliminating the need to use the mouse to click on the mute icon on the GUI of the application program 138b.

With reference to the embodiment of FIG. 1C, in some implementations, no synchronization exists among the application program 138c and the fast control program 134c. Under this scenario, the fast control program 134c mutes or unmutes the microphone 136c at the OS level as illustrated in FIG. 1C. In one embodiment, the fast control program 134c sets a system mute software 148c to mute or unmute the microphone 136c and the application program 138c will not be able to change the mute status of the microphone 136c. When a user mutes or unmutes the microphone 136c through the fast control device 100c, the mute status on the GUI of the application program 138c does not change.

With reference to the embodiment of FIG. 1D, in some implementations, one directional synchronization exists among the application program 138d and the fast control program 134d. Under this scenario, when a user mutes or unmutes the microphone 136d through the fast control device 100d, the mute status on the GUI of the application program 138d changes. In addition, the application program 138d is not able to mute or unmute the microphone 136d. FIG. 1D illustrates one embodiment to implement the one directional synchronization scheme, where the fast control program 134d mutes or unmutes the microphone 136d through a system mute software 148d and informs the application program 138d of this mute or unmute operation. It is to be appreciated that other implementations not departing from the spirit of the one directional synchronization are available and should fall into the scope of the present invention.

With reference to the embodiment of FIG. 1E, in some implementations, bi-directional synchronization exists among the application program 138e and the fast control program 134e. Under this scenario, both the application program 138e and the fast control program 134e can mute or unmute the microphone 136e. When the application program 138e mutes or unmutes the microphone 136e, the mute status on the GUI of the fast control program 134e changes and the light source on the fast control device 100e may change color. When a user mutes or unmutes the microphone 136e through the fast control device 100e, the mute status on the GUI of the application program 138e changes as well. FIG. 1E illustrates one embodiment to implement the bi-directional synchronization scheme, where both the application program 138e and the fast control program 134e can mute or unmute the microphone 136e and both programs exchange mute or unmute status with each other. It is to be appreciated that other implementations not departing from the spirit of the one directional synchronization are available and should fall into the scope of the present invention.

FIG. 1F, by way of example, illustrates the options available in the GUI of the fast control program 134b to configure the fast control device 100b in FIG. 1B. Note that the same operation principle can be applicable to FIG. 1A, 1C, 1D, or 1E. A user may configure the fast control device 100b by changing the options on a GUI of the fast control program 134b. In some embodiments, the GUI of the fast control program 134b shows message such as “device is unconnected” (not shown here) when the fast control program 134b is not able to detect the fast control device 100b. The GUI may prompt a user to reconnect the fast control program 134b and the fast control device 100b by displaying message such as “try reconnect” once the user confirms the fast control device 100b is wired or wirelessly connected with the computing device 130b. Once the fast control program 134b can detect the fast control device 100b, the icon on the top right corner of the GUI turns green as shown in FIG. 1F.

In some embodiments, the fast control program 134b allows a user to hide its GUI in the background of the desktop of the operating system, minimize its GUI, or stays its GUI in front of the desktop over the GUI of the application program 138b or any other application programs of the computing device 130b.

In some embodiments, the fast control program 134b provides different muting or unmuting methods associated with the fast control device 100b available to a user. In one embodiment, the microphone 136b can be muted when the user touches the fast control device 100b and unmuted when the user touches the fast control device 100b again, as illustrated by the option “Toggle” under the “Muting Method:” in FIG. 1F. In one embodiment, the user unmutes the microphone 136b by keeping pressing the contact unit of the fast control device 100b and once the user stops pressing, the microphone 136b is muted, as illustrated by the “Push-To-Talk” option. In one embodiment, the user mutes the microphone 136b by keeping pressing the contact unit of the fast control device 100b, and once the user stops pressing, the microphone 136b is unmuted, as illustrated by the “Push-To-Mute” option. In one embodiment, the microphone 136b can be muted by voice control (not shown here). In this scenario, the microphone 136b is muted when the user utters one phrase (such as “Mute Me”) and unmuted when the user utters another phrase (such as “Unmute Me”). The voice control phrase can be customized or sound recorded by the user in advance to replace a default mute or unmute phrase.

In some embodiments, the color of the light source of the fast control device 100b is programmable and a user can change colors of the light source for indicating mute or unmute status of the microphone 136b. In one embodiment, the light source supports eight colors for indicating the mute or unmute status of the microphone and a user can set the colors through the GUI of the fast control program 134b, as illustrated under the “When I am Muted:” and “When I am Unmuted:” options in FIG. 1F.

In some embodiments, the light source of the fast control device 100b support different lighting effect under a programmed color. In one embodiment, the light source emits bright color, as illustrated by the option “Bright” horizontal to the “Effect:” in FIG. 1F. In one embodiment, the light source emits dim color, as illustrated by the option “Dim” horizontal to the “Effect:” in FIG. 1F. In one embodiment, the light source pulsates with high frequency as illustrated by the option “Fast Pulse” horizontal to the “Effect:”. In one embodiment, the light source pulsates with low frequency as illustrated by the option “Slow Pulse” horizontal to the “Effect:”.

In some embodiments, the fast control device 100b can be programmed to generate a sound (such as beep) when a user mutes or unmutes the microphone 136b by contacting, as illustrated by the option “Play a sound when muting” and “Play a sound when unmuting.”

In some embodiments, the GUI of the fast control program 134b allows user to set different modes of synchronization as described above among the fast control program 134b and the application program 138b, as illustrated by the “Sync Settings” in the left side of the GUI in FIG. 1F.

FIG. 1G illustrates a non-limiting embodiment for implementing the fast control device 100b depicted in FIG. 1B. The fast control device 100g has a contact unit 102g, a light source 104g, a communication interface 108g, and a microcontroller 106g. The contact unit 102g receives a contact from the user. The light source 104g emits light based on the mute or unmute status of the microphone 136b of the computing device 130b in FIG. 1B. The communication interface 108g transmits an electrical signal through a wired or wireless connection 120g to the computing device 130b. The microcontroller 106g controls the light source 104g and the communication interface 108g.

In one embodiment, the contact unit 102g is a capacitive touch panel. When a user touches the panel, an electrical signal is generated and transmitted to the computing device 130b through the communication interface 108g to mute or unmute the microphone 136b. In one embodiment, the contact unit 102g is a mechanical button. When a user pushes down the button, the microphone 136b of the computing device 130b is muted. When a user pushes again the button, the button bounces up and the microphone 136b of the computing device 130b is unmuted.

In some embodiments, the light source 104g is a LED light. In one embodiment, the light source 104g is capable of emitting multiple colors such as red, blue, purple, green and so on. In one embodiment, the light source 104g can pulsate at low frequency (e.g. 0.5 Hz) or high frequency (e.g. 2 Hz). In one embodiment, the light source 104g can emit brightly (with higher light output such as 10 W). In one embodiment, the light source 104g can emit dimly (with lower light output such as 1 W).

In some embodiments, the communication interface 108g is a USB interface circuitry that connects the fast control device 100g with the computing device 130b through a USB cord. In some embodiments, the communication interface 108g is a wireless communication circuitry such as a Bluetooth circuitry that connects the fast control device 100g with the computing device 130b wirelessly.

In some embodiment, the microcontroller 106g may be an application processing unit (APU), a central processing unit (CPU) or a microprocessor.

Although not illustrated in FIG. 1G, the fast control device 100g can take the shape of a cylinder or other shapes such as a cube or a cuboid.

FIG. 1H illustrates an embodiment of a system for turning on or turning off a camera 150h connected to a computing device 130h through a fast control device 100h. The camera 150h can be a built-in camera of the computing device 130h, wired (such as USB) or wirelessly (such as Bluetooth) connected to the computing device 130h.

The fast control device 100h has a contact unit (such as a touch panel or a button) that is used to quickly turn on or turn off the camera 150h when contacted by a user. The camera 150h can be turned on or turned off by the application program 138h through an input device 146h (such as a mouse) of the computing device 130h. The application program 138h may be a video conference program such Zoom, Line, Webex, Skype, Google Meet, GoToMeeting, Microsoft Teams or other video conferencing programs. In some embodiments, a user may turn off the camera 150h by using a mouse to click on a camera icon presented by the graphical user interface (GUI) of the application program 138h.

The camera 150h can also be turned on or off by the fast control program 134h through the fast control device 100h. The fast control program 134h is a software program specifically developed to coordinate with the fast control device 100h to quickly and reliably turn on or off the camera 150h. In some embodiments, a user may turn on or off the camera 150h by touching or pressing the contact unit of the fast control device 100h, eliminating the need to use the mouse to click on the camera icon on the GUI of the application program 138h.

Other aspects of the invention regarding turning on or off the camera 150h can be similarly implemented by coordinating the fast control device 100h with the computing device 130h based on principles and embodiments illustrated above regarding muting or unmuting the microphone 136b of the computing device 130b in FIG. 1B, and thus will not be repeated for the sake of brevity.

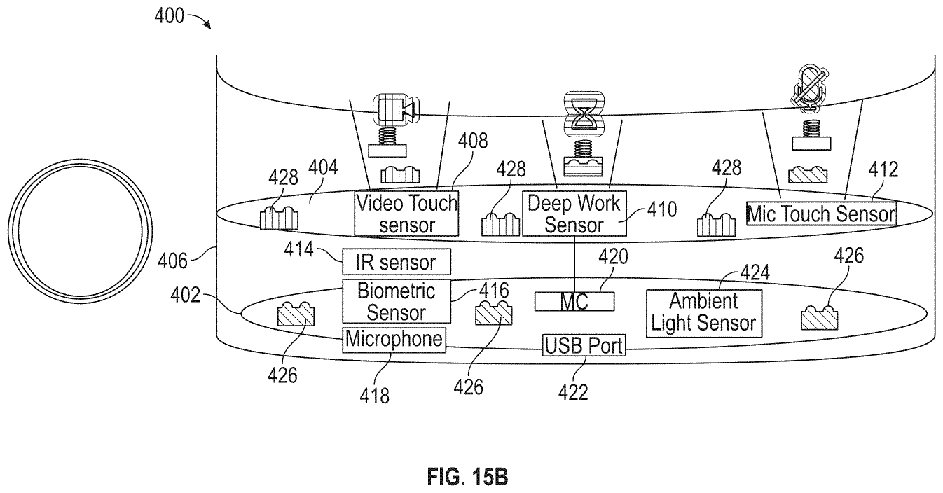

FIG. 1I illustrates an embodiment of a computing system where the fast control device 100i can be used to quickly and reliably control the microphone 136i and the camera 150i of the computing device 130i. The principles illustrated above for controlling a microphone 136i or a camera 150i of a computing device 130i can be applicable to FIG. 1I to allow a user to mute/unmute the microphone 136i and turn on or turn of the camera 150i through the fast control device 100i. To enable the fast control device 100i in FIG. 1I to control both the microphone 136i and the camera 150i, one can modify the physical structure of the fast control device 100g in FIG. 1G, which will be described with greater detail in FIGS. 15A and 15B.

### Examples

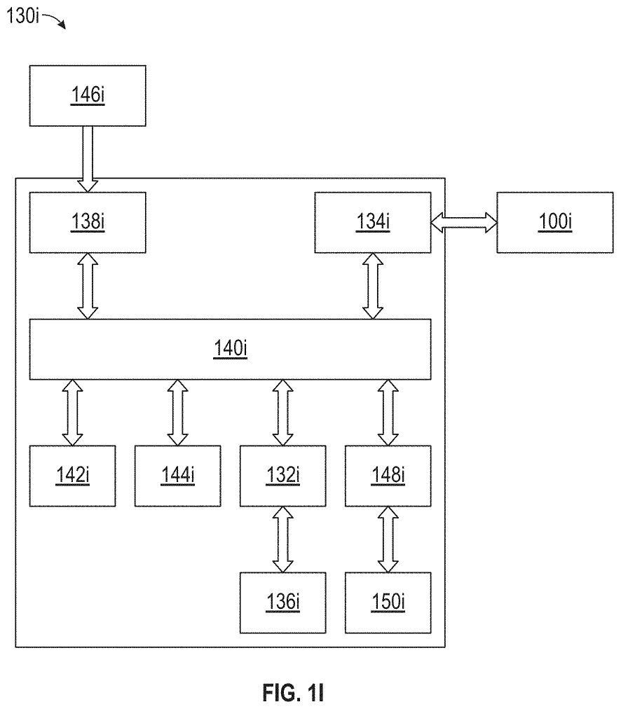

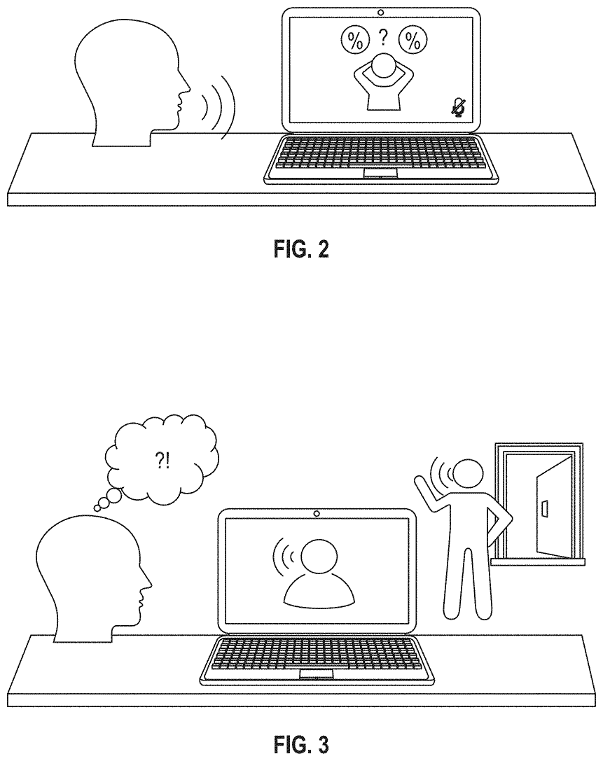

FIG. 2 illustrates an example of a user being muted and talking. In this example, the user does not realize they are muted, and those on the other end of the visual conference and the user cannot hear the user and miss information. The user generally has to repeat information after figuring out they are muted and unmuting their device.

FIG. 3 illustrates an example of an unmuted user and listening to a video conference. In this example, others around the user are not aware of the user is on a call and speak unfiltered, thus, interrupting the call.

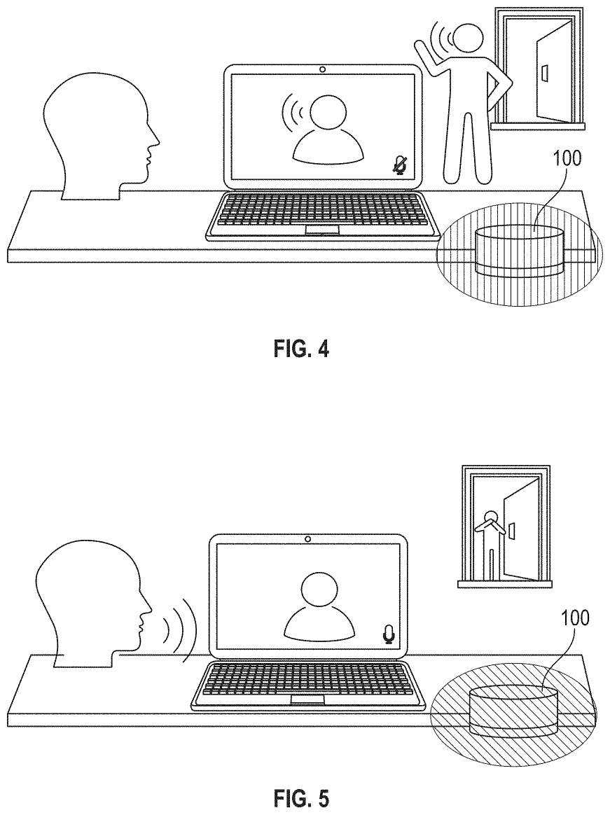

FIG. 4 illustrates an example of a muted user. In this example, a user and those around the user immediately see the user is muted by the visual device 100 and can proceed accordingly. In the example of FIG. 4, the visual device 100 may emit red light to indicate that the user is muted.

FIG. 5 illustrates an example of an unmuted user. In this example, others around the user are immediately informed by the visual device 100 that the user is likely on a call and can come back for further conversation when the user indicates from the visual device 100 when it is safe to approach. In the example of FIG. 5, the visual device 100 may emit green light to indicate that the user is unmuted.

FIG. 6 illustrates an aspect of the visual device 100 with two distinct visual colors from LED lights. For example, the visual device 100A may be emitting red light to indicate that the user is muted and the visual device 100B may be emitting green light to indicate that the user is unmuted.

FIG. 7 illustrates an aspect of the visual device 100 and customization of colors for people who are color blind. People with protanopia are unable to perceive any ‘red’ light, those with deuteranopia are unable to perceive ‘green’ light and those with tritanopia are unable to perceive ‘blue’ light. People with both red and green deficiencies live in a world of murky greens where blues and yellows stand out. Browns, oranges, shades of red and green are easily confused. Both types will confuse some blues with some purples and both types will struggle to identify pale shades of most colors. The most common color confusions for tritanopes are light blues with greys, dark purples with black, mid-greens with blues and oranges with reds. Thus, color arrangements can be made to accommodate the various color confusions for people with color blindness. For example, the visual device 100 may be configured to emit blue light when muted and yellow light when unmuted for user's having deuteranopia. The visual device 100 may further be configured to emit magenta light when muted and cyan light when unmuted for user's having tritanopia.

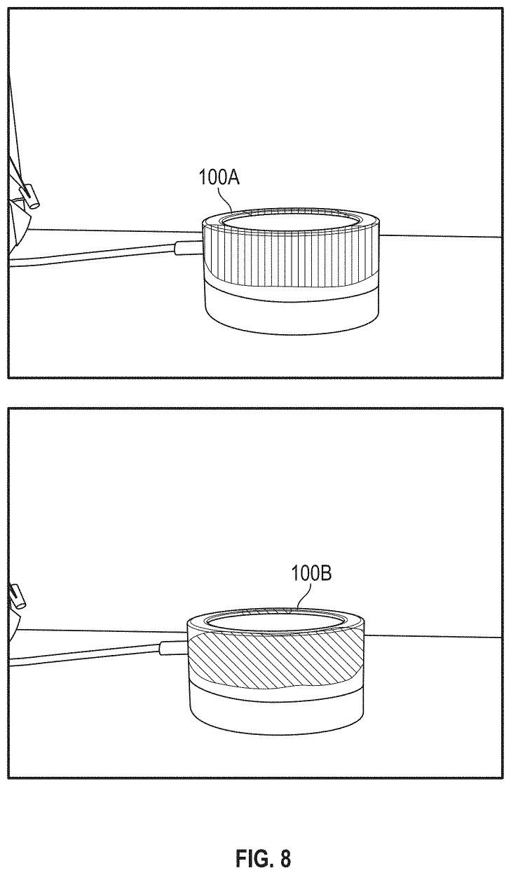

FIG. 8 illustrates an aspect of the visual device 100 connected to a computer 130 with two distinct LED light settings. For example, in a first setting, the visual device 100A may emit red light and in a second setting, the visual device 100B may emit green light. In some implementations, the visual device 100 is configured to receive instructions from a user to select a different color, or have the visual device 100 turned completely off when not on a call. For example, the visual device 100 may have at least three different LED settings, including a first setting when the user is on a call and unmuted, a second setting when the user is on a call and muted, and a third setting when the user is not on a call.

FIG. 9A illustrates an aspect of a miniaturized visual device 140. FIG. 9B illustrates a different view of the aspect of the miniaturized visual device 140 of FIG. 9A. In some embodiments, the miniaturized visual device 140+of FIGS. 9A and 9B can be connected directly to a USB port of a computer (e.g., similar to a flash drive). Alternatively, the miniaturized visual device can be connected to a USB port indirectly (e.g., via a USB extension cable or a USB hub).

### Examples Related to Webcam Control, Microphone Control, and Synchronization

Virtual meetings are becoming more pervasive and significant, especially during the Covid-19 pandemic. But video conferencing problems continue to be the cause of embarrassment and perceived distractions because the person using virtual meetings is not able to quickly turn their camera on and off, or does not know if their camera is on or off. As a result, there needs to be a quick and obvious solution to let the user turn their camera on and off, to know what their status is, and to let those around the user know if a video conference is occurring whether or not the camera is on or off.

Virtual meetings are becoming more pervasive for not only for adults, but also for children. Camfecting, the process of attempting to hack into a person's webcam and activate it without the webcam owner's permission, is also a growing concern. Not being able to immediately recognize if your webcam is on or off is a growing concern. It is desirable to clearly see if webcam is on or off to prevent hacking. Most of the time, embedded cameras are always-on cameras.

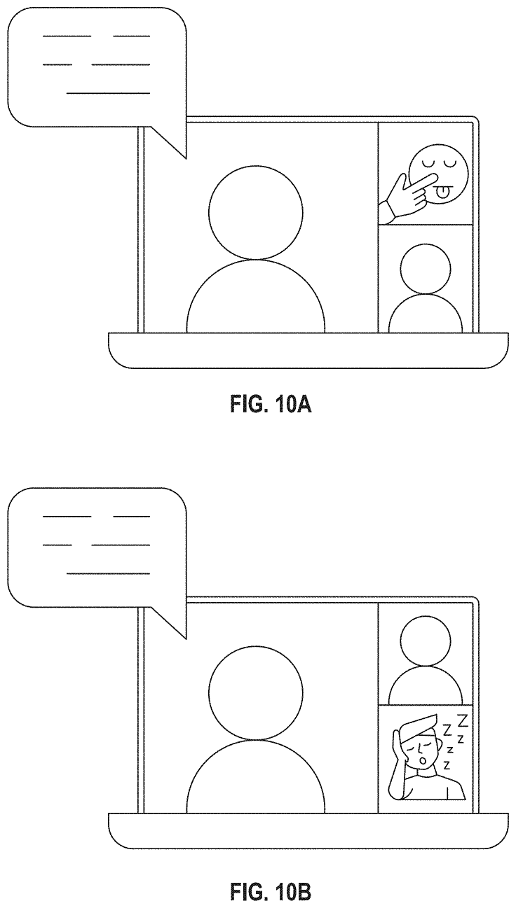

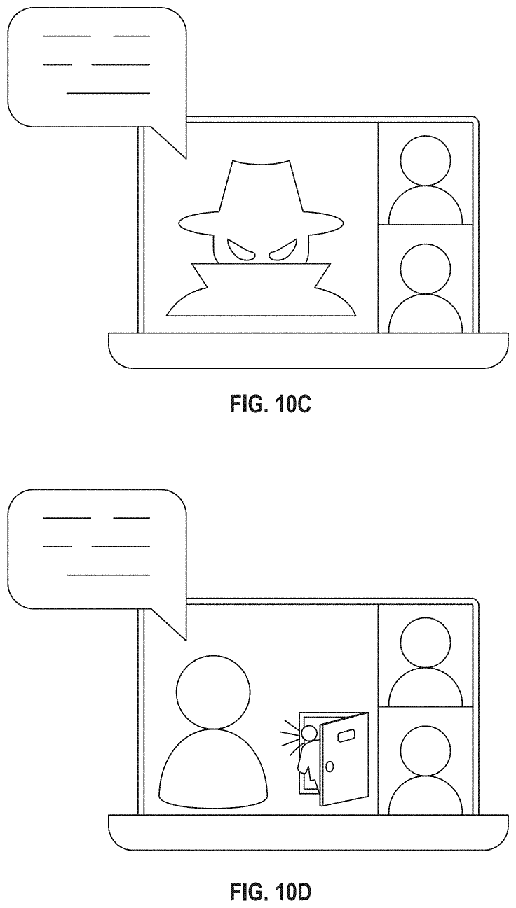

FIGS. 10A-10D illustrate four examples of a user's webcam being on and the user forgetting or those around them not knowing. Knowing when a webcam is on or off may not always obvious to the user or those around them. Knowing when the webcam is on and off may be desirable for a number of different reasons, some of which are listed below.

FIG. 10A illustrates an embodiment in which one or more users may be engaged in private activities. As shown in FIG. 10B, certain users may come off as unprofessional.

FIG. 10C illustrates a potential vulnerability where a webcam may be hacked without the approval of the user. For example, the user may not be aware that the webcam is hacked and can be turned on by the hacker, which may enable the hacker to watch the user via the webcam.

FIG. 10D illustrates an environment in which others around the user may not be aware that the user is currently participating in a conference call with the webcam on resulting in avoidable interruptions and distractions.

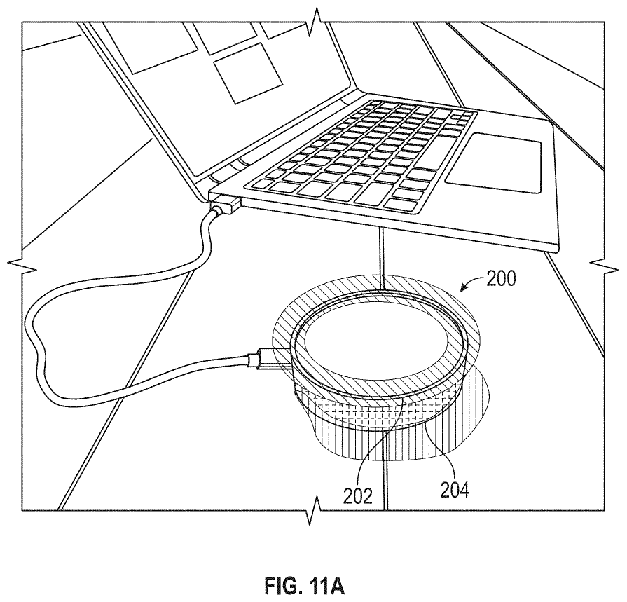

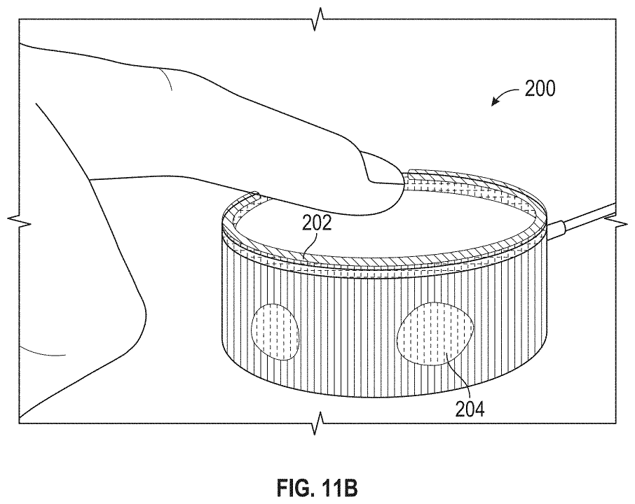

FIGS. 11A-11B illustrate example views of a visual device system 200 in accordance with an embodiment of the disclosure.

The visual device system includes an illuminated button that allows the user and others around the user to know a webcam or camera status 202 and microphone status 204 (e.g., as described in Provisional Patent Application No. 63/114,442, filed Nov. 16, 2020) for a webcam and a microphone connected to and/or included in a computer connected to the visual device system. The system can both turns the webcam on and off and synchronize the displayed statuses 202 and 204 with the conferencing software.

FIGS. 11A and 11B illustrate the display of the camera status 202 via a first portion of the visual device 200 and the display of the microphone status 204 via a second portion of the visual device 200.

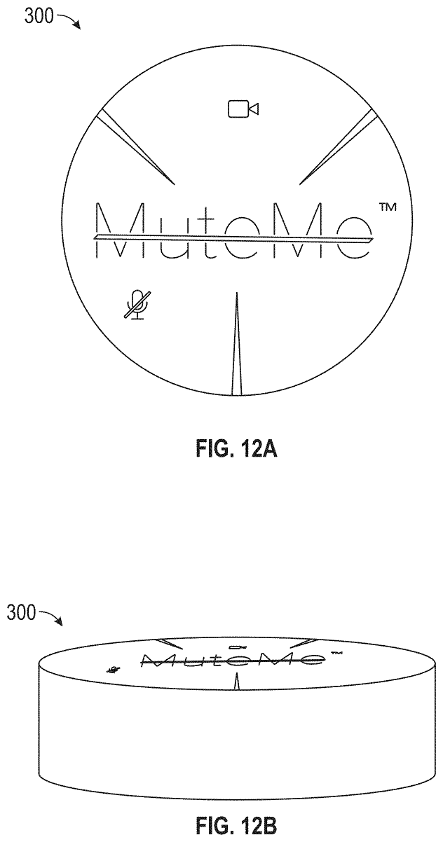

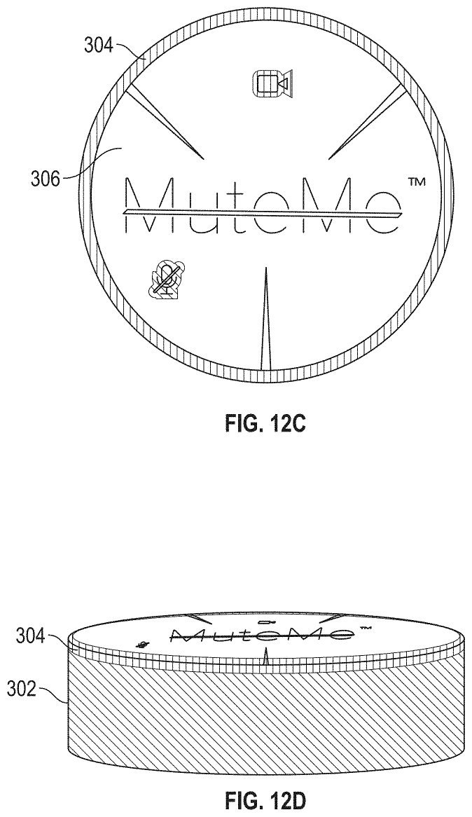

FIGS. 12A-12D illustrate a number of views of an embodiment of the visual device system 300 with examples of different capabilities of the device 300.

With reference to FIGS. 12A-12D, the visual device 300 can be configured to visually convey the status of a user's webcam and microphone, as well as other conferencing software features such as hand raised, accept/end call, etc. In particular, the visual device 300 may be configured to synchronize with conferencing software running on the connected computer. The microphone mute/unmute status 302 may be displayed on a first portion of the visual device 300, and the webcam on/off status 304 may be displayed on a second portion of the visual device 300. The visual device 300 may also have one or more user choice buttons 306 (e.g., which may be implemented push and/or touch buttons) located on a third portion of the visual device 300.

The one or more user choice buttons 306 may be configured to implement one or more of the following functions: microphone, camera, busy, raise hand, accept call, user choice, accept/end call, screen sharing, and/or other conference software features.

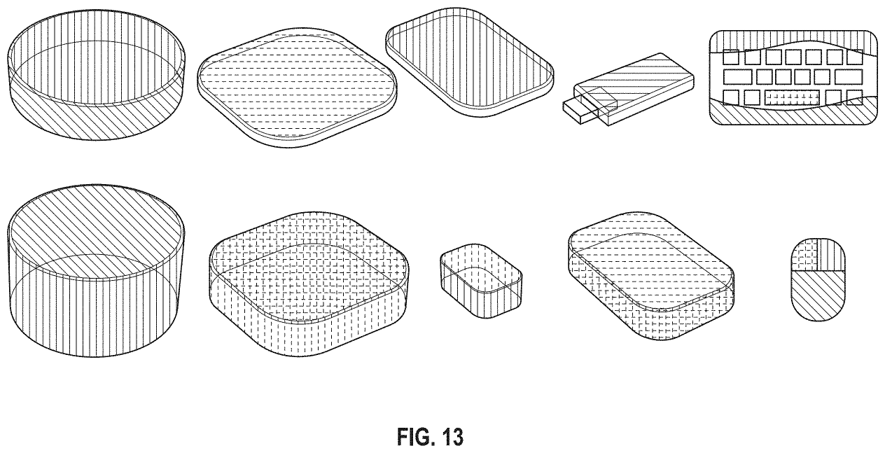

FIG. 13 illustrates a number of different form factors in which the visual device can be implemented in accordance with aspects of this disclosure. In particular, the visual device is not restricted to a specific shape or size and can be implemented in various different shapes and/or sizes. The connection between the visual device and a computer may be direct wireless, indirect wireless via the internet, wired either directly or indirectly, and/or a direct USB plug-in. The visual device may also be implemented using one or more different color options.

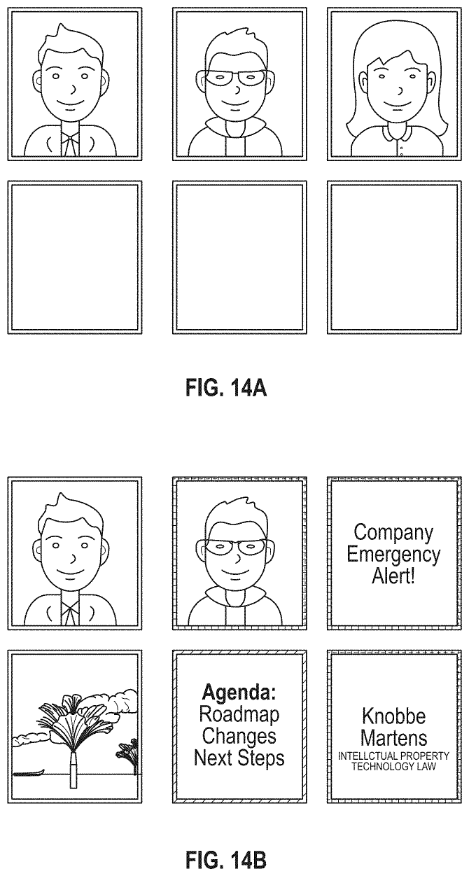

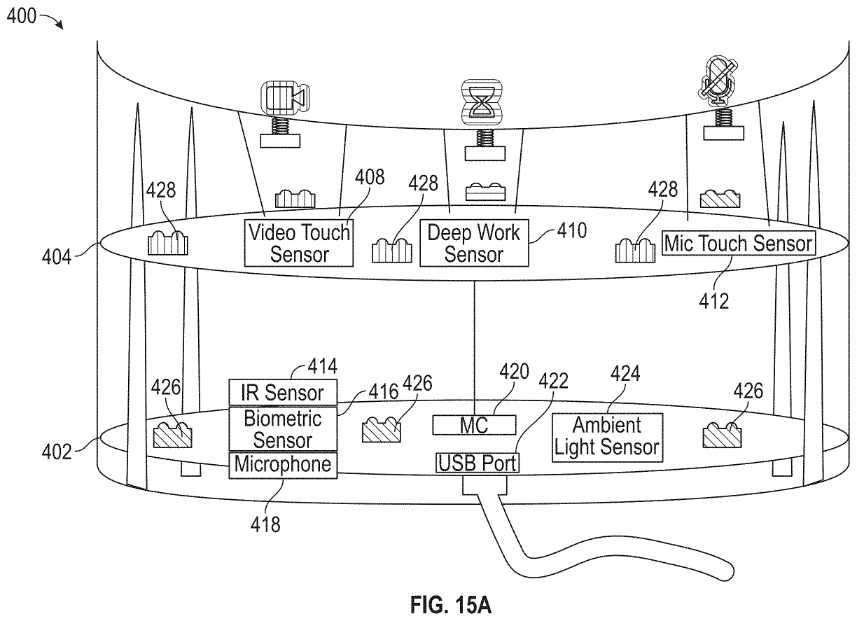

FIGS. 14A-14B illustrates an embodiment of a virtual device camera system that sits on the user's computer and allows the user to customize their output video feed. The virtual device camera system includes webcam software technology configured to allows a user to stand out on video conferencing calls indicating they are using the webcam software technology. Using the webcam software, a user can denote microphone status, branding, team colors, and/or one or more other statuses such as requesting to speak. The webcam software allows for conference software users to easily decipher status, intentions, and/or obtain information quickly, such as company-wide notifications.

The output video stream can conditionally change depending on user conditions (e.g., time, location, etc.), team and/or company conditions (emergencies, events, branding initiatives, etc.).

FIGS. 15A-15B illustrates an example internal design of a visual device 400 in accordance with aspects of this disclosure. In some embodiments, the visual device 400 includes two PCB boards 402 and 404 stacked strategically to allow for dual-status 360° visual identification colors (in one example, webcam and microphone statuses). On the top of the visual device 400, individual sensors and compartmentalization allows for illuminated icons for push-button or capacitive control. In some embodiments, non-PCB barriers can be used to create different sections of colors.

With reference to FIG. 15B, a second PCB 404 can rest on a mold or rim formed on the interior of a case of the device 400, thereby preventing light diffusion from a first PCB 402 through the second PCB/mold 404 and 406. The first PCB 402 may be formed to be smaller than mold/rim, allowing the first PCB 402 to be dropped into the device 400 to the bottom of the case.

In some embodiments, the visual device 400 can include a single PCB and a barrier to provide for the dual-status 360° visual identification colors. In some embodiments, three or more visual layers can be provided via a combination of PCBs and/or barrier layers.

With continued reference to FIGS. 15A and 15B, the visual device 400 can further include a video touch sensor 408, a deep work sensor 410, a microphone touch sensor 412, an infrared (IR) sensor 414, a biometric sensor 416, a microphone 418, a microcontroller 420, a USB port 422, and an ambient light sensor 424. The visual device 400 can also include a first set of LEDs 426 formed on the first PCB 402 and a second set of LEDs 428 formed on the second PCB 404. The first and second set of LEDs 426 and 428 can be configured to emit light of different wavelengths, and thus, provide two separate visual indicators regarding the status of the microphone and/or video, in one example.

FIG. 16 illustrates a block diagram which can implement the microphone mute/unmute synchronization system. In particular, the block diagram of FIG. 16 illustrates a number of different embodiments of the microphone mute/unmute synchronization system which can be connected to a visual device 500 including a first sensor 502, a second sensor 504, a third sensor 406, a microcontroller 507, a USB port 508, and one or more LEDs 510.

A first embodiment (Microphone Control #1) 512 corresponds to the embodiment described above in connection with FIG. 1. The microphone control #1 512 includes an OS microphone controller 514, a toggle 516, a microphone 518, and conferencing software 520.

A second embodiment (Microphone Control #2) 522 is configured to use a screen reading controller 524 to detect what the mute/unmute status is when the user mutes/unmutes using conferencing software 530 and/or the visual device system 500. The microphone control #2 522 includes the screen reading controller 524, a toggle 526, a microphone 528, and the conferencing software 530.

A third embodiment (Microphone Control #3) 532 include a microphone controller 534 which is configured to enable/disable the microphone driver using a detecting script (e.g., a plug and play (PnP) detecting script) when the user mutes/unmutes using the conferencing software 540 and/or the visual device system 500. The microphone control #3 532 includes the microphone controller 534, a toggle 536, a microphone 538, and the conferencing software 540.

A fourth embodiment (Microphone Control #4) 542 is configured to pass along commands (e.g., human interface devices (HID) commands) from the visual device system 500 to a virtual microphone. The microphone control #4 542 includes a microphone controller 544, conferencing software 546, microphone software 548, an HID virtual microphone 550, and a microphone 552. The visual device system 500 controls the virtual microphone 550 and the virtual microphone 550 controls or receives input from the microphone 552 (e.g., default microphone). The virtual microphone 550 also connects to the conferencing application 546. A user can select the virtual microphone 550 as their default microphone, allowing the visual device system's 500 microphone software to pass along HID commands from the visual device system 550 peripheral to the computer. This allows for 100% two-way synchronization without the need to use keyboard commands. The virtual microphone 550 can then sync with popular conferencing applications and pass along and receive HID USB commands as if it was a real microphone with the visual device system 500.

Each of the first to third embodiments (Microphone Control #1-3) 512, 524, and 532 may all be configured to use a HID virtual microphone as described in connection with the fourth embodiment (Microphone Control #4).

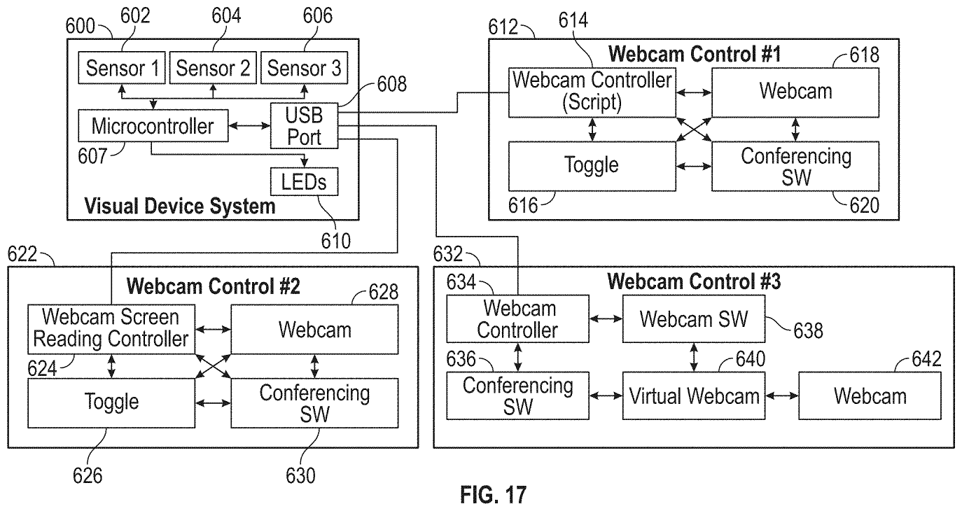

FIG. 17 illustrates another embodiment of the webcam on/off synchronization system which may be coupled to up to three different webcam control systems 612, 622, and 632. Similar to FIG. 16, the visual device system 600 includes a first sensor 602, a second sensor 604, a third sensor 606, a microcontroller 607, a USB port 608, and one or more LEDs 610.

The first webcam control system (Webcam control #1) 612 can be configured to control turning the default webcam 618 on/off by using a webcam controller 614 which enables/disables the webcam driver using a detecting script (e.g., a PnP detecting script for Windows systems). The first webcam control system 612 includes the webcam controller 614, a toggle 616, the webcam 618, and conferencing software 620.

The second webcam control system (Webcam Control #2) 622 can be configured to sync with a conferencing software 630 of choice. The second webcam control system 622 includes a webcam screen reading controller 624, a toggle 626, a webcam 628, and the conferencing software 630. When a shortcut or the conferencing software 630 turns the camera 628 on/off, the webcam screen reading controller 624 can be configured to read the screen and sync with the conferencing software 630.

The third webcam control system (Webcam Control #3) 632 can be configured to pass along HID commands to a virtual webcam 640. The third webcam control system includes a webcam controller 634, conferencing software 636, webcam software 638, the virtual webcam 640, and a webcam 642. The virtual webcam 640 may be located between the visual device system 600 and the default webcam 642. A user can select the virtual webcam 640 as their default webcam, allowing the webcam software 638 to pass along HID commands from the visual device system 600 peripheral to the computer and popular conferencing applications 636. This allows for 100% two-way synchronization without the need to use keyboard commands. This further enables the webcam software 638 to allow users and/or companies to customize the feed allowing for overlays of information as illustrated in FIGS. 14A and 14B. The first and second webcam control systems (Webcam Control #1-2) 612 and 622 can be configured to use the HID virtual webcam described in the third webcam control system (Webcam Control #3) 632.

In some embodiments, a toggle comprises a volume control for muting or unmuting the microphone controller. In some embodiments, the toggle comprises a volume control for the speaker controller. In some embodiments, the toggle comprises a volume control for the camera controller. In some embodiments, the toggle comprises a component with control handling logic for receiving commands from the visual device. In some embodiments, the visual device further comprises one or more microcontrollers. In some embodiments, the visual device further comprises a button. In some embodiments, the visual device further comprises of one or more capacitive touch sensors.

In some embodiments, the visual device further comprises one or more visual indicators. In some embodiments, the one or more visual indicators is one or more LED light bands.

In some embodiments, a method of controlling a computer microphone includes pushing a button, touching a button, or using voice commands on the visual device thereby activating the visual device; communicating the visual device activation to a computer; changing a microphone setting on the computer as a result of the visual device activation. In some embodiments, changing the setting on the computer results in muting the microphone. In some embodiments, changing the setting on the computer results in activating the microphone or virtual microphone. In some embodiments, the activating the visual device comprises activating a visual indicator on the visual device. In some embodiments, the visual indicator comprises two or more LED lights.

Some aspects described herein related to a visual system for controlling a webcam. In some embodiments, the visual system for controlling a computer webcam includes a visual device having configurable control to change the settings in response to an event, a method to disable/enable the webcam device, a method for screen reading the microphone status, a software application system having event handling logic for receiving a signal from the visual device of the event and communicating with the computer webcam controller.

In some embodiments, the system further comprising a toggle operably coupled to the webcam controller for inputting a command to change a setting of the webcam controller. In some embodiments, the toggle comprises a component with control handling logic for receiving commands from the visual device.

In some embodiments, the visual system for controlling a computer webcam includes a virtual webcam system that sits between the visual device and conferencing software. The visual device has configurable control to change the settings of the virtual webcam system, which is selected as the default webcam, in response to an event, and an operating system that is coupled to the conferencing software, the operating system having event handling logic for receiving a signal from the virtual webcam system of the event and communicating with the computer operation system controller.

Some aspects of the disclosure relate to a method of controlling a computer webcam. In some embodiments the method includes receiving an event, communicating the event to a visual device, and changing the setting on the visual device to indicate the status of a webcam during the conferencing call.

In some embodiments, the receiving event can come from the conferencing software or application on the computer system, and the visual device system is communicated the event and synchronization occurs. In some embodiments, a receiving event comprises receiving an event by the visual device that changes the status of the webcam, microphone, and logs the user out, or a combination thereof. In some embodiments, a receiving event comprises receiving an event by the visual device that changes the status of both the webcam and microphone. In some embodiments, the receiving event is at the application level. In some embodiments, the receiving event is at the operating system level. In some embodiments, the receiving event is at the application level and the operating system level.

In some embodiments, a method of controlling a computer webcam includes pushing a button, touching a button, using voice commands, using gesture control on the visual device thereby activating the visual device; communicating the visual device activation to a computer; changing a microphone setting on the computer as a result of the visual device activation. In some embodiments, changing the setting on the computer results in turning off the webcam. In some embodiments, changing the setting on the computer results in activating the webcam. In some embodiments, the activating the visual device comprises activating a visual indicator on the visual device. In some embodiments, the visual indicator comprises one or more LED lights. In some embodiments, the visual indicator comprises two or more LED lights.

Some aspects of the disclosure relate to a method of controlling a computer webcam video stream. In some embodiments the method includes receiving an event, communicating the event to a visual device, changing the setting on the visual device system to indicate the status of a camera, and an overlay with selected customized user information during the video conferencing call.

In some embodiments, the receiving event comprises receiving an event generated by an application. In some embodiments, the receiving event comprises receiving an event generated by a video conferencing call. In some embodiments, the changing the setting of the visual device comprises changing a visual indicator from the visual device. In some embodiments, the setting of visual device comprises turning off or disabling the default video output of the webcam during the video conferencing call.

In some embodiments, the visual device system communicates with the virtual webcam via a USB device, which can trigger a pre-selected overlay of the outgoing video stream. In some embodiments, an HID command is communicated from the visual device system to the virtual webcam, triggering a pre-selected overlay of the outgoing video stream. The overlay can be user specified, company specified, or conditionally specified.

In some embodiments, the visual device further comprises one or more microcontrollers. In some embodiments, the visual device comprises of one or more PCB boards. In some embodiments, the visual device comprises of one or more partitions to prevent light bleed.

In some embodiments, the visual device further comprises of two or more partitions, stacked, with control for spacing controlled by stepped pillars.

In some embodiments, the visual device further comprises a button. In some embodiments, the visual device further comprises of one or more capacitive touch sensors. In some embodiments, the visual device comprises of other input command sensors like voice or noise commands.

In some embodiments, the visual device further comprises one or more visual indicators. In some embodiments, the one or more visual indicators is one or more LED light bands. In some embodiments, the visual device further comprises one or more visual indicators. In some embodiments, the one or more visual indicators is one or more LED lights.

In some embodiments, the visual device is wirelessly connected to the webcam controller system. In some embodiments, the visual device comprises a wired connection between the visual device and the webcam controller system. In some embodiments, the visual device comprises a direct USB connection between the visual device and the computer.

### Examples Related to Motion Detection, Biometric Sensors, Status Control, and Internet-of-Things (IoT) Devices

More and more people are using conferencing software and computers in general to complete their work. Many times we are running late to meetings or have assignments with nearing deadlines. It is becoming more important to reduce wasting time turning on a computer from standby, sleep mode, or on off mode. By having the monitor turn on when motion is detected, the information is immediately visible and the monitor usage and power consumption are reduced.

For those working in an office, motion detection can be valuable information for the employer or corporation. Motion detection at one's desk can help the employer make changes to heating and lighting to allow for utmost comfort or savings on power consumption. Of course, motion detection can also be tied into other sensors a user may have at home as well (lighting, localized heating) to allow for increased comfort.

For those working in an office, motion detection can also help employers set up conditional alerts, like reminders to take a break, like emergency messaging, write onto the computer user's screen.

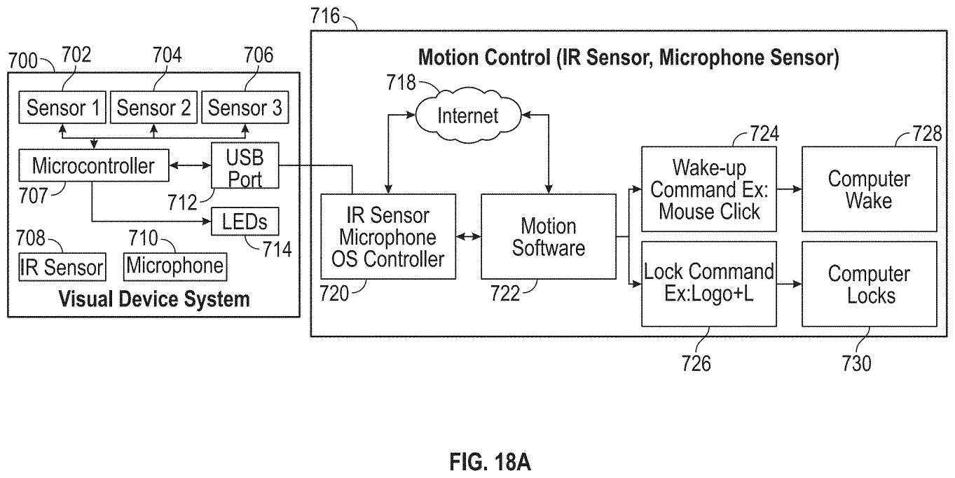

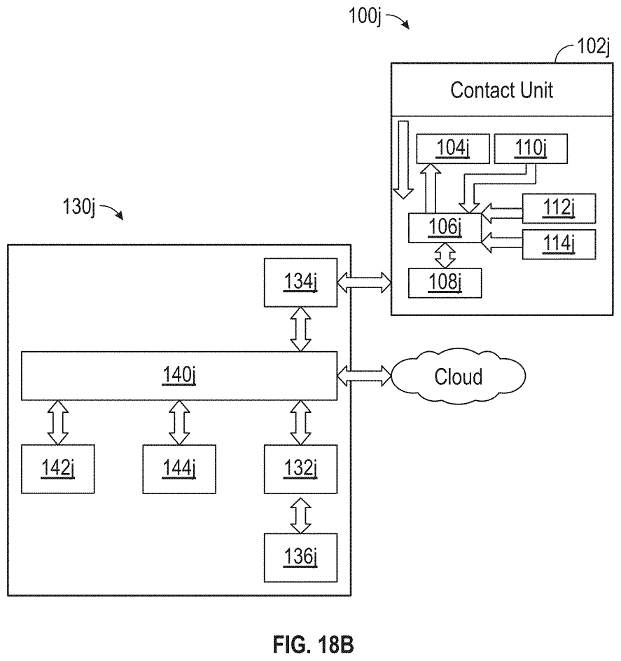

FIG. 18A illustrates an embodiment of a motion activated visual device system 700. The visual device system 700 includes a first sensor 702, a second sensor 704, a third sensor 706, a microcontroller 707, an infrared (IR) sensor 708, a microphone 710, a USB port 712, and one or more LEDs 714. The visual device system 700 is connected to a motion controller 716 which includes an Internet (e.g., cloud) interface 718, an IR sensor, microphone, and OS controller 720, motion software 722, wake-up command (e.g., a mouse click) software 724, lock command (e.g., logo+L) software 726, computer wake software 728, and computer lock software 730. The visual device system 700 can be configured to detect motion using one or more sensors to wake up the computer and/or lock the computer. The motion software 722 can be connected to the cloud 718 to allow for data collection of the user when they are near their computers or not. Cloud connectivity 718 allows for enabling smart-home, smart-office features and makes the visual device system 700 an internet of things device.

In some embodiments, the motion activated visual device system 700 includes the IR sensor 708 and the microphone sensor 710. In some embodiments, the motion activated visual device system 700 includes the IR sensor 708 without the microphone sensor 710. In some embodiments, the visual device system 700 includes an illuminated USB HID device configured to connect to a user's computer and pass on commands to lock, unlock (e.g., if no sign-on conditions), and power on a computer based off of IR motion sensor 708 and/or with a microphone sensor 710.

FIG. 18B illustrates another embodiment of a visual device 100j and a computing device 130j. The visual device 100j can be configured to detect motion of the user using the motion sensor 112j (such as an IR sensor) or detect a sound of the user using the sound sensor 114j (such as a microphone). The detected motion or sound can be used to perform some operations on the computing device 130j. In some embodiments, when it is determined by the microcontroller 106j that the user of the visual device 100j is not present for certain amount of time based on the sensor data provided by the motion sensor 112j or the sound sensor 114j, the microcontroller 106j sends a motionless notification signal to the fast control program 134j through the communication interface 108j. The fast control program 134j forwards this signal to the operating system 140j, which in turn sends a trigger signal to control the peripheral device 136j through the peripheral driver 132j. In one embodiment, the peripheral 136j is a monitor associated with the computing device 130j (such as a monitor of a laptop or smartphone or an external monitor of a PC) and the monitor is turned off to save power. In one embodiment, the operating system 140j brings the entire computing device 130j into sleep mode to save power. In one embodiment, the operating system 140j locks the computing device 130j to prevent unauthorized access.

In some embodiments, the sensor data from the motion sensor 112j or the sound sensor 114j received by the operating system 140j is further uploaded to and collected by the Cloud for further analysis and usage.

In some embodiments, the visual device 100j may further include a biometric sensor 110j that detects some biometric information (such as fingerprints) of a user to perform some operation on the computing device 130j (such as lock or unlock the computing device). In one embodiment, when the biometric information is verified by the microcontroller 106j to be the rightful user, the computing device 130j is unlocked and the light source 104j emits a particular light (such as green light) to signal the unlocking. In one embodiment, when the biometric information doesn't pass the verification by the microcontroller 106j, the microcontroller 106j sends a locking signal to lock the computing device 130j and the light source 104j emits a warning light (such as red-light) to warn that unauthorized access is happening. The communication interface 108j may further send a warning message to the rightful user when unauthorized access is attempted.

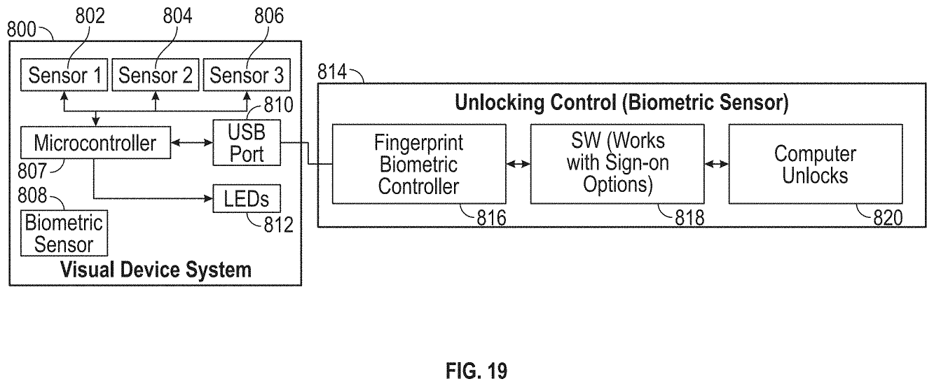

FIG. 19 illustrates an embodiment of a motion activated visual device system 800 configured to unlock based on one or more sign-on conditions. The visual device system 800 includes a first sensor 802, a second sensor 804, a third sensor 806, a microcontroller 807, a biometric sensor 808, a USB port 810, and one or more LEDs 812. The visual device system 800 is connected to an unlocking controller 814 which includes a fingerprint biometric controller 816, biometric software 818, and computer unlock software 820. The visual device system 800 can unlock a user's computer using a biometric sensor pad 808 that is included on the visual device system 800. The software 818 can be configured to allow for designated people, like parents, to unlock the computer. In some embodiments, the visual device system 800 includes an illuminated USB HID device configured to connect to a user's computer and unlock the computer based on a fingerprint biometric sensor 808.

People are spending more and more time at their desks and on their computers. As we log more ours staring at screen while at work and outside work, it is more important than ever to ensure maximum comfort. Connecting our device to a system of devices allows for sharing and collecting of information enabling users and employers to automate tasks, collect data, and take actions on that data to drive down cost and increase efficiency. For example, having a visual device system become an IOT device allows it to connect to lighting, heating, and other device sensors around the workplace that can adjust conditionally and save time while we rush to the next meeting.

More and more people are working or learning from home (especially during COVID-19). Many times, in a multi-person home, we are constantly interrupting our routine and physically checking on the availability of the other person. By having devices that reveal that status of the individual, whether kids or a spouse, be digitally connected, it further promotes ease of information.

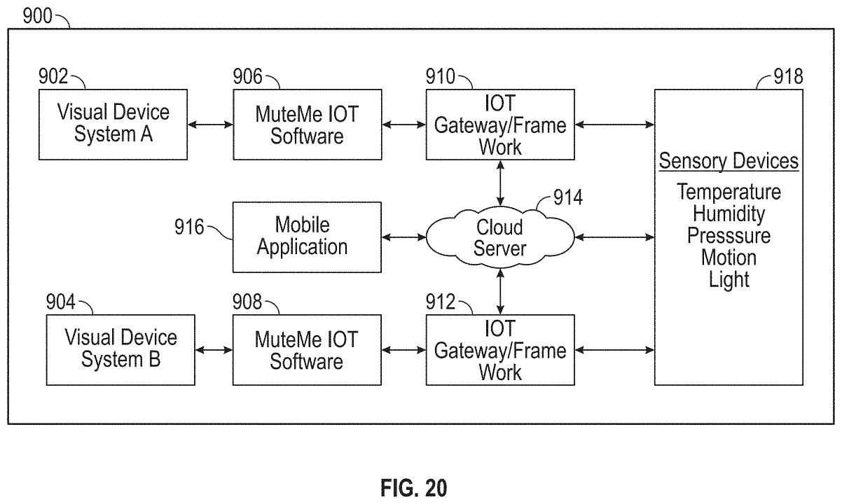

FIG. 20 illustrates an embodiment of a visual device IOT framework. The visual device system A and visual device system B can exchange their status with each other through the IoT framework. In one embodiment, the visual device system B (or the MuteMe Dvice) is the visual device in FIG. 1A or the fast control device in FIG. 1B. In one embodiment, when an user unmutes a microphone of a computer, the visual device system B changes its lighting color to, for example, red. The information that the visual device system B is in unmute status or having red lighting is passed to the IoT Gateway/Framework through the MuteMe IoT software, which is then sent to the Cloud Server. The visual device system A may access such information from the Cloud Server through its IoT software. In one embodiment, the MuteMe IoT software is installed in a computer physically nearby the visual device system B.

In some embodiments, a visual device system includes an illuminated USB device, that is configured to function as a smart device and connect to other smart home/office features, and conditionally respond (e.g., the visual device is activated once lights are turned on, etc).

The IOT device system 900 can include a first visual device system A 902, a second visual device system B 904, first IOT software 906, second IOT software 908, a first IOT gateway/framework 910, a second IOT gateway/framework 912, a cloud server interface 914, a mobile application 916, and one or more sensory devices 918. The sensory devices 918 may include one or more of the following: a temperature sensor, a humidity sensor, a pressure sensor, a motion sensor, and/or a light sensor.

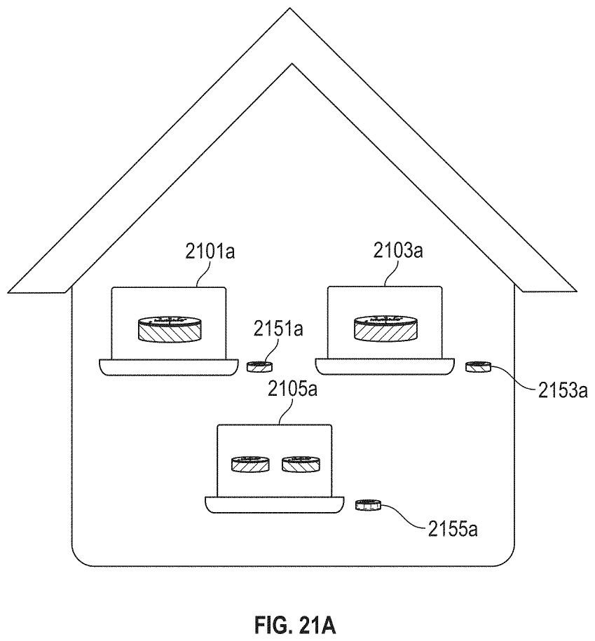

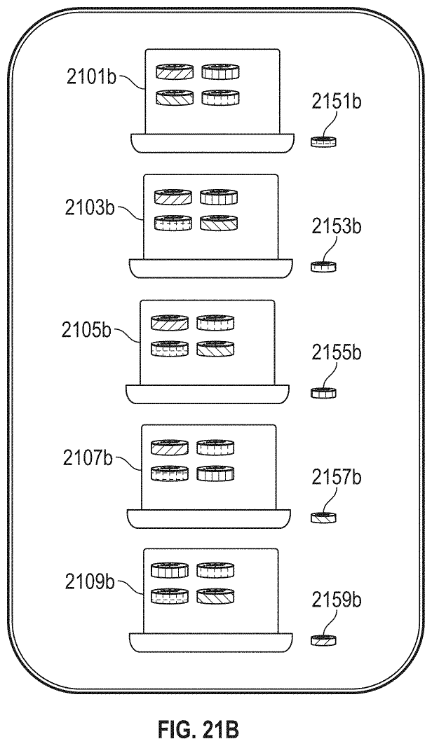

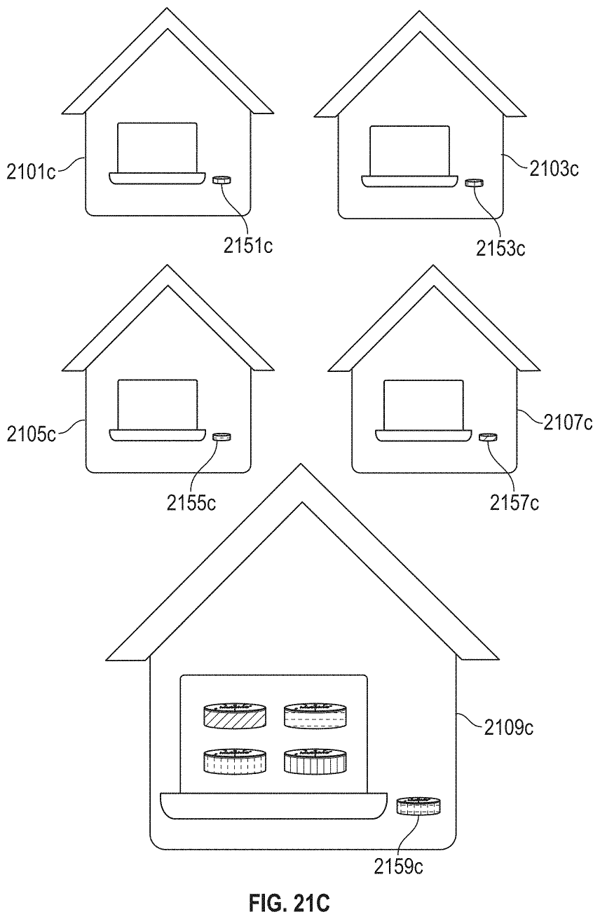

FIGS. 21A-21C illustrate embodiments of user-to-user connected visual device system use cases. Users can see other visual device systems and their status in multiple use cases.

In FIG. 21A, a user-to-user device connection or parent-child device connection within close proximity (e.g., spouses with different offices can see each other's status, or parent can see children's device status). In one embodiment, the user 2101a operates the visual device 2151a, the status of which is made known to the user 2103a. In one embodiment, the user 2103a operates the visual device 2153a, the status of which is made known to the user 2101a. In one embodiment, the user 2105a operates the visual device 2155a and both the status of the visual device 2151a and the visual device 2153a are made known to the user 2105a.

In FIG. 21B, a group-group device connection within large office building (ex: teams can see each other and/or search others' status regardless of their location). In one embodiment, the user 2101b operates the visual device 2151b, the status of which is made known to the user 2103b, the user 2105b, the user 2107b, and the user 2109b. Similarly, the status of the visual device of another user is made known to the rest of users. In this way, each user is informed the status of others, such as whether the cameras of others are on or off or the microphones of others are muted or unmuted.

In FIG. 21C, a one-way device status detection is shown (e.g., a teacher teaching virtually can see the status of their students, in this case the grey visual device detects the child is not at their desk (e.g., a motion sensor is built into the device)). In one embodiment, the user 2109c can unilaterally monitor the visual device system status of the user 2101c, the user 2103c, the user 2105c and the user 2107c. In one embodiment, motion sensor built into the visual device 2155c detects that the user 2105c is not beside her computer and the visual device 2155c emits grey light, which signals to the user 2109c that the user 2105c is not beside her computer.

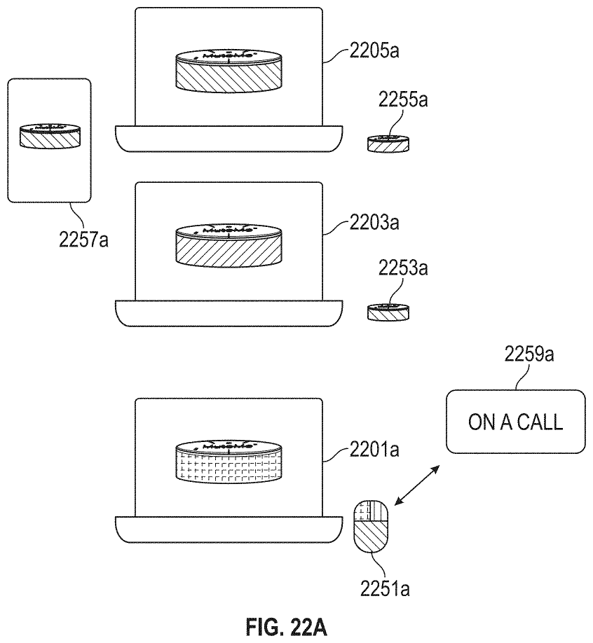

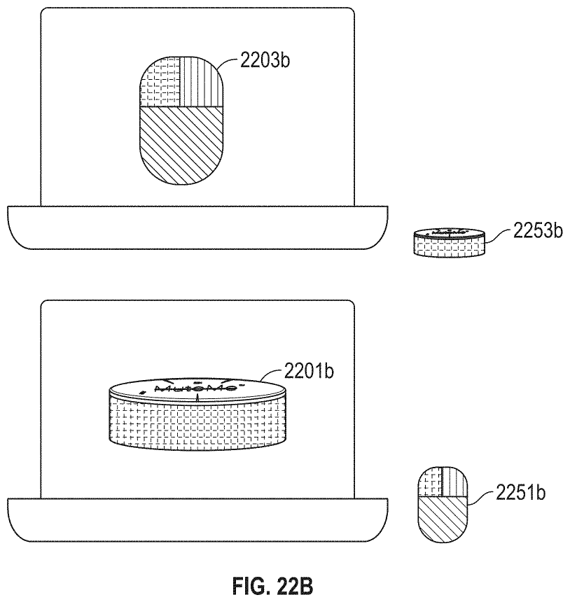

FIGS. 22A-22B illustrate examples of user-to-user connected visual device system technologies. In some embodiments, visual device systems can connect to each other, future form factors/devices, applications, or complimentary devices we are working on.

In FIG. 22A, users can see the status of another visual device system on their computer or through an application. The visual device system (e.g., mouse, any embodiment of the visual device disclosed herein, etc.) can also connect to a sign (e.g., placed in the vicinity of the user's workplace) that can relay status to those outside the user's office/cube. In one embodiment, the visual device 2251a operated by the user 2201a takes the shape of a mouse. When the user 2201a is on a call, the top right portion of the visual device 2251a emits red light to signal the user 2201a is on a call. Such information is relayed (such as through IoT techniques) to a sign 2259a (such as a bar or display panel) associated with the user 2201a to inform others that the user 2201a is on a call.

In FIG. 22B, users can see the status of another visual device system.

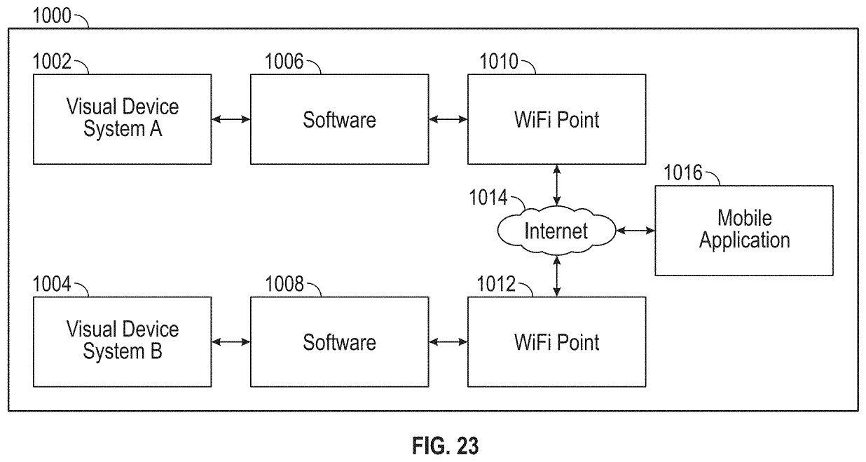

FIG. 23 illustrates an example user-to-user connected visual device system. The visual device system status can transmit and receive status to and from another system. The other system can be a visual device system or another IOT device in the home, office, etc.

In some embodiments, a visual device system includes an illuminated USB HID device, that is configured to connect (e.g., one-way, two-way, or multiple-ways) to other visual device systems through the cloud and is further configured to relay status (controlled by the user, guardians, or supervisory organization).

The system 1000 of FIG. 23 can include a first visual device system A 1002, a second visual device system B 1002, first software 1006, second software 1008, a first WiFi point 1010, a second WiFi point 1012, an Internet interface (e.g., router/modem) 1014, and a mobile application 1016.

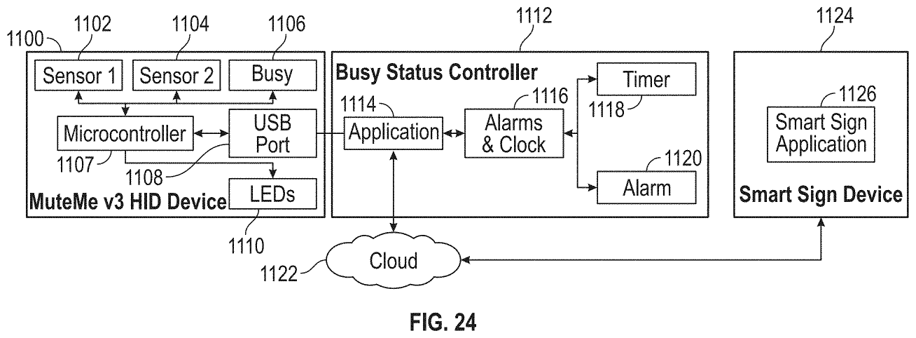

FIG. 24 illustrates an example visual device system 1100 with a busy sensor 1106. The visual device system 1100 includes a first sensor 1102, a second sensor 1104, a busy sensor 1106, a microcontroller 1107, a USB port 1108, and one or more LEDs 1110. The visual device system 1100 is connected to a busy status controller 1112 which includes a software application 1114, alarms and clock software 1116, a timer 1118, and an alarm 1120. The busy status controller 1112 is connected to the cloud 1122 and a smart sign device 1124 which includes a smart sign application 1126. The visual device system 1100 has a user activated busy sensor 1106 that changes the color of the device 1100 to indicate status (e.g., busy, available, customizable status). This status can be timed (e.g., 30 min, etc.), for example, using the timer 1118. Further, this status information can be sent to a smart sign 1124 that can display the status (and any associated time) to let those around the user know the status before they enter the user's office/workspace. The connection between the Smart Sign 1124 and computer or visual device 1100 can be directly to the computer, wired or wireless (cloud, Bluetooth, etc.).

In some embodiments, a visual device system, an illuminated USB HID device, that is configured to give the user the ability to set their status (e.g., busy, journaling, ideation, illustrating, etc.), choose to define time, and also transmit this information to a smart sign that can be placed outside the workspace for decreased interruptions.

In some embodiments, the visual device system can also be configured to perform motion detection and/or home/office automation leaving the video conferencing application space and into IOT space. This can have impact on lighting (e.g., in an office setting) and/or heating. The visual device system can light up a little more when it senses a user. Motion can be activated by a presence sensor.

In some embodiments, the presence sensor can be configured to activate the user's computer (similar to mouse movement). The combination of the presence sensor and a biometric sensor can work together to log a user onto their computer. The presence sensor can further be configured to work with smart home devices at home.

In some embodiments, if the visual device system is connected to smart home, then work information can be translated throughout the house. For example, an incoming call can be broadcasted to devices within the user's house.

In some embodiments, the presence sensor can be used to save on battery of the visual device system (e.g., when implemented wirelessly).

In some embodiments, the presence sensor can be used to detecting multiple people in one location and/or can be used to adjust lighting and heating.

In some embodiments, one or more conditions can be used to control smart home devices, for example, when all people have left (as detected by the presence sensor) and the time is 5 pm or later, then the system can turn off lights.

In some embodiments, the visual device system can send alerts (i.e., emergency alerts) to computers that show an indication of presence based on a presence sensor.

What is claimed is:

1. A visual system for controlling a microphone, comprising:
a visual device having configurable control to change a setting of a computer microphone in response to an event; and
an operating system operably coupled to a microphone controller, the operating system having event handling logic for receiving a signal from the visual device of the event and communicating with the computer operation system microphone controller.

2. The system of claim 1, wherein the visual device further comprises one or more visual indicators.

3. The system of claim 2, wherein the one or more visual indicators comprise one or more LED lights.

4. The system of any of claims 1-3, wherein the visual device is wirelessly connected to the operating system.

5. The system of any of claims 1-4, wherein the visual device comprises a wired connection between the visual device and the operating system.

6. The system of any of claims 1-5, further comprising a toggle operably coupled to the operating system for inputting a command to change a setting of the microphone controller.

7. The system of claim 6, wherein the toggle comprises a volume control for muting or unmuting the microphone controller.

8. The system of any of claims 6-7, wherein the toggle comprises a component with control handling logic for receiving commands from the visual device.

9. The system of any of claims 1-8, wherein the visual device further comprises a microcontroller.

10. The system of any of claims 1-9, wherein the visual device further comprises a button or a touch sensor.

11. A method of controlling a computer microphone, comprising:
receiving an event;
communicating the event to a visual device; and
changing the setting on the visual device to indicate the status of a microphone during the video conferencing call.

12. The method of claim 11, wherein the receiving event comprises receiving an event generated by an application.

13. The method of claim 11, wherein the receiving event comprises receiving an event generated by a video conferencing call.

14. The method of any of claims 11-13, wherein the changing the setting of the visual device comprises changing a visual indicator from the visual device.

15. The method of any of claims 11-13, wherein changing the setting of visual device comprises muting the default audio output of the microphone during the video conferencing call.

16. A method of controlling a computer microphone, comprising:
pushing a button on the visual device thereby activating the visual device;
communicating the visual device activation to a computer; and
changing a microphone setting on the computer in response to a signal received by the visual device.

17. The method of claim 16, wherein changing the setting on the computer results in muting the microphone.

18. The method of claim 16, wherein changing the setting on the computer results in activating the microphone.

19. The method of any one of claims 16-18, wherein the activating the visual device comprises activating a visual indicator on the visual device.

20. The method of claim 19, wherein the visual indicator comprises two or more LED lights.

21. A visual system for controlling a webcam, comprising:
a visual device configured to control to change a setting of a computer webcam in response to an event;
a visual device operably coupled to a webcam controller, the webcam comprising event handling logic for receiving a signal from the visual device of the event and communicating with a webcam controller;
a visual device coupled to the webcam controller configured to execute a detecting script to enable/disable the webcam;
a visual device coupled to the webcam controller comprising a webcam screen status detection; and
a visual device coupled to the webcam controller and configured to control a virtual or non-virtual webcam.

22. The system of claim 21, wherein the visual device further comprises one or more visual indicators.

23. The system of claim 22, wherein the one or more visual indicators comprises one or more LED lights.

24. The system of any of claims 21-23, wherein the visual device is configured to be wirelessly connected to the webcam controller.

25. The system of any of claims 21-24, wherein the visual device is configured to be connected to the operating system using a wired connection.

26. The system of any of claims 21-25, wherein the visual device comprises a USB connection configured to connect to the operating system.

27. The system of any of claims 21-26, further comprising a toggle operably coupled to the webcam controller and configured to receive a command to change a setting of the webcam controller.

28. The system of any of claims 26-27, wherein the toggle comprises a component configured to receive commands from the visual device.

29. The system of any of claims 21-28, wherein the visual device further comprises a microcontroller.

30. The system of any of claims 21-29, wherein the visual device further comprises a button.

31. The system of any of claims 21-29, wherein the visual device further comprises a touch sensor or voice command receiver.

32. A method of controlling a computer webcam, comprising:
receiving an event;
communicating the event to a visual device; and
changing the setting on the visual device to indicate the status of a webcam during the video conferencing call.

33. The method of claim 32, wherein the receiving event comprises receiving an event generated by an application.

34. The method of claim 32, wherein the receiving event comprises receiving an event generated by a video conferencing call.

35. The method of any of claims 32-34, wherein the changing the setting of the visual device comprises changing a visual indicator from the visual device.

36. The method of any of claims 32-34, wherein changing the setting of visual device comprises turning off the default video output of the webcam during the video conferencing call.

37. A method of controlling a computer webcam, comprising:
pushing a button on the visual device thereby activating the visual device;
communicating the visual device activation to a computer; and
changing a webcam setting on the computer as a result of the visual device activation.

38. The method of claim 37, wherein changing the setting on the computer results in turning off the webcam.

39. The method of claim 37, wherein changing the setting on the computer results in activating the webcam.

40. The method of any one of claims 37-39, wherein the activating the visual device comprises activating a visual indicator on the visual device.

41. The method of claim 40, wherein the visual indicator comprises two or more LED lights.

42. A visual system for controlling a webcam, comprising:
a visual device configured to change a setting of a computer webcam in response to an event;
a visual device coupled to a virtual webcam, the virtual webcam configured to receive a signal from the visual device of the event and communicate with the computer virtual webcam through human interface devices (HID) commands;
a visual device coupled to a webcam controller configured to execute a plug and play (PnP) detecting script for the webcam; and
a visual device coupled to the webcam controller and configured to perform screen webcam status detection.

43. The system of claim 42, wherein the visual device further comprises one or more visual indicators.

44. The system of claim 43, wherein the one or more visual indicators comprises one or more LED lights.

45. The system of any of claims 42-44, wherein the visual device is configured to be wirelessly connected to the virtual webcam.

46. A visual system for controlling a microphone, comprising:
a visual device configured to change a setting of a computer microphone in response to an event; and
a virtual microphone configured to receive commands from the visual device.

47. The system of claim 46, wherein the received commands comprise human interface devices (HID) commands.

48. The system of claim 46, wherein the system is configured to controls the virtual microphone and the virtual microphone is configured to controls or receive input from the computer microphone.

49. The system of claim 46, wherein the virtual microphone is configured to connect to conferencing software.

50. The system of claim 46, wherein the system is configured to receive a selection from a user to select the virtual microphone as a default microphone, wherein the visual device system further comprises microphone software configured to pass along commands from the visual device system peripheral to the computer.
